(19) United States
(12) Patent Application Publication
(10) Pub. No.: US 2026/0134531 A1
(43) Pub. Date: May 14, 2026

(54) APPARATUS FOR AND METHOD OF ANALYZING COATED STATE OF ELECTRODE PLATE OF SECONDARY BATTERY

(71) Applicant: SAMSUNG SDI CO., LTD., Yongin-si (KR)

(72) Inventors: Gee Eun LIM, Yongin-si (KR); Sung Hun KIM, Yongin-si (KR); Jun Sub LEE, Yongin-si (KR); Sang Hyun YOO, Yongin-si (KR); Geon Soo KIM, Yongin-si (KR)

(21) Appl. No.: 19/347,892

(22) Filed: Oct. 2, 2025

(30) Foreign Application Priority Data
Nov. 8, 2024 (KR) 10-2024-0158329

(51) Int. Cl. G06T 7/00; G01N 21/84; G01N 21/88; H01M 4/04

(52) U.S. Cl. CPC G06T 7/0008; G01N 21/8422; G01N 21/8806; G06T 7/97; G01N 2021/8427; G01N 2021/8809; G06T 2207/30108; G06T 2207/30204; H01M 4/0404

(57) ABSTRACT

The present disclosure relates to an apparatus for and method of analyzing a coated state of an electrode plate of a secondary battery and is directed to providing an apparatus for and method of analyzing coated stated of first and second coating materials located on first and second surfaces of an electrode plate, respectively. To this end, the present disclosure provides embodiments in which a target image of a surface of an electrode plate is acquired, markers are overlaid on the surface of the electrode plate, and a mismatch of coating properties of first and second coating materials located respectively on first and second surfaces of the electrode plate is determined based on the markers on the target image.

### CROSS-REFERENCE TO RELATED APPLICATION

This application claims priority to and the benefit of Korean Patent Application No. 10-2024-0158329, filed on Nov. 8, 2024, the disclosure of which is incorporated herein by reference in its entirety.

### BACKGROUND

### 1. Field

The present disclosure relates to an apparatus for and method of analyzing a coated state of an electrode plate of a secondary battery.

### 2. Description of the Related Art

Unlike primary batteries that cannot be recharged, secondary batteries are batteries that can be charged or discharged. Low-capacity secondary batteries are used in small portable electronic devices, such as smartphones, feature phones, laptop computers, digital cameras, and camcorders, and high-capacity secondary batteries are widely used as power sources for driving motors in hybrid vehicles, electric vehicles, etc. and as batteries for power storage. Such a secondary battery includes an electrode assembly consisting of a positive electrode and a negative electrode, a case accommodating the electrode assembly, an electrode terminal connected to the electrode assembly, etc.

An electrode process of manufacturing an electrode, which is a component of a secondary battery, comprises a coating process of coating a surface of a metal current collector with an active material and an insulating material to form a positive electrode and a negative electrode, a rolling process (or roll press process) of rolling a coated electrode plate, and a slitting process of cutting a rolled electrode plate according to dimensions.

The above information disclosed in this Background section is for enhancement of understanding of the background of the present disclosure, and therefore, it is not necessarily intended to constitute related (or prior) art.

### SUMMARY

The present disclosure is directed to providing an apparatus for and method of analyzing a coated state of an electrode plate of a secondary battery. The apparatus and the method allow one to analyze a coated state of a coating material with which each of upper and lower surfaces of an electrode current collector is coated by a coating process constituting an electrode process.

However, objects that the present disclosure intends to achieve are not limited to the above-described objects and other objects that are not described may be clearly understood by those skilled in the art from the following description.

According to an aspect of the present disclosure, there is provided an apparatus for analyzing a coated state of an electrode plate of a secondary battery, with a first coating material and a second coating material being located on first and second surfaces of the electrode plate, respectively. The apparatus includes a marker generation module; an image acquisition module configured to acquire a target image including a first image and a second image of the first surface and the second surface of an electrode plate, respectively, wherein markers generated by the marker generation module are overlaid on the first and second surfaces of the electrode plate, and the first coating material and the second coating material are located on the first and second surfaces of the electrode plate, respectively; and a processor configured to determine a mismatch between coating properties of the first coating material on the first surface of the electrode plate and coating properties of the second coating material on the second surface of the electrode plate by analyzing the first and second images included in the target image using the markers on the target image acquired by the image acquisition module.

The image acquisition module may include an image recognition sensor, a first mirror, and a second mirror, the first and second mirrors may be configured to reflect light incident from the first and second surfaces of the electrode plate, respectively, to the image recognition sensor, and the image recognition sensor images the first and second mirrors to acquire the target image including the first and second images on the first and second surfaces, respectively.

The first mirror may be spaced apart from the first surface of the electrode plate and the second mirror may be spaced apart from the second surface of the electrode plate, the first and second mirrors may be disposed symmetrically with respect to an optical axis of the image recognition sensor, and the image recognition sensor may have an FOV including a first FOV that covers the first mirror and a second FOV that covers the second mirror.

The first and second FOVs may correspond to the first and second images of the target image, respectively.

The markers may include a first sub-marker in a form of a line and a second sub-marker in a form of a line that are formed from a base marker that is applied by the marker generation module toward the electrode plate, the first sub-marker and the second sub-marker being overlaid on the first and second surfaces, respectively, and the first sub-marker and the second sub-marker function as analysis criteria for the first and second images.

The base marker may be applied by the marker generation module is reflected to each of the first and second mirrors.

The first and second sub-markers may be composed of continuous lines on the target image.

The coating properties may include a position of a coating material on a surface of the electrode plate, and the processor may determine a positional mismatch between the first and second coating materials using the first and second sub-markers.

The processor may be configured to determine whether there is a positional mismatch between the first and second coating materials when a distance between the first sub-marker and the first coating material is different from a distance between the second sub-marker and the second coating material on the target image.

The FOV of the image recognition sensor may further include a third FOV that covers a third surface of the electrode plate, the target image may further include a third image acquired by the image recognition sensor capturing the third surface of the electrode plate, and the coating properties may include a thickness of a coating material on a surface of the electrode plate.

The processor may be configured to determine that there is a thickness mismatch between the first and second coating materials when a width of the first coating material is different from a width of the second coating material on the target image.

The marker generation module and the image acquisition module may be a first marker generation module and a first image acquisition module, respectively, the first marker generation module may be disposed on a first side of the electrode plate, the first image acquisition module may be disposed on the first side of the electrode plate and acquires a first target image including a first image and a second image of a first area of the first surface and a first area of the second surface, respectively, markers generated by the first marker generation module are respectively overlaid on the first area of the first surface and the first area of the second surface of the electrode plate, a second marker generation module may be disposed on a second side of the electrode plate, a second image acquisition module may be disposed on the second side of the electrode plate and acquires a second target image including a fifth image and a sixth image of a second area of the first surface and a second area of the second surface, respectively, and markers generated by the second marker generation module are respectively overlaid on the second area of the first surface and the second area of the second surface of the electrode plate.

The processor may be configured to: determine a mismatch between the coating properties of the first coating material in the first area of the first surface of the electrode plate and the coating properties of the second coating material in the first area of the second surface of the electrode plate by analyzing the first and second images included in the first target image using the markers on the first target image acquired by the first image acquisition module; and determine a mismatch between the coating properties of the first coating material in the second area of the first surface of the electrode plate and the coating properties of the second coating material in the second area of the second surface of the electrode plate by analyzing the fourth and fifth images included in the second target image using the markers on the second target image acquired by the second image acquisition module.

The processor may be configured to: determine a mismatch between the coating properties of the first coating material in the first area of the first surface of the electrode plate and the coating properties of the first coating material in the second area of the first surface of the electrode plate; and determine a mismatch between the coating properties of the second coating material in the first area of the second surface of the electrode plate and the coating properties of the second coating material in the second area of the second surface of the electrode plate.

The coating properties may include a coating direction of a coating material on a surface of the electrode plate, and the processor is configured to: determine that there is a coating direction mismatch of the first coating material according to each area of the first surface when a distance between a marker overlaid on the first area of the first surface of the electrode plate and the first coating material on the first target image is different from a distance between a marker overlaid on the second area of the first surface of the electrode plate and the first coating material on the second target image; and determine that there is a coating direction mismatch of the second coating material according to each area of the second surface when a distance between a marker overlaid on the first area of the second surface of the electrode plate and the second coating material on the first target image is different from a distance between a marker overlaid on the second area of he second surface of the electrode plate and the second coating material on the second target image.

The first target image may further include a third image of a third surface of the first side of the electrode plate acquired by the first image acquisition module, the second target image may further include a sixth image of a fourth surface of the second side of the electrode plate acquired by the second image acquisition module, and the coating properties may include a thickness of a coating material on a surface of the electrode plate.

The processor may be configured to: determine that there is a thickness mismatch of the first coating material according to each area of the first surface when a width of the first coating material on the first target image is different from a width of the first coating material on the second target image, and determine that there is a thickness mismatch of the second coating material according to each area of the second surface when a width of the second coating material on the first target image is different from a width of the second coating material on the second target image.

The first and second marker generation modules may be symmetrically disposed on the first and second sides of the electrode plate, respectively, and the first and second image acquisition modules may be symmetrically disposed on the first and second sides of the electrode plate, respectively.

According to another aspect of the present disclosure, there is provided a method of analyzing a coated state of an electrode plate of a secondary battery. The method includes acquiring, by a processor, a target image through an image acquisition module, wherein the image acquisition module is configured to acquire the target image including a first image and a second image of a first surface and a second surface of an electrode plate, respectively, with a first coating material and a second coating material being located on the first and second surfaces of the electrode plate, respectively, markers generated by a marker generation module are overlaid on the first and second surfaces of the electrode plate, and the first coating material and the second coating material are located on the first and second surfaces of the electrode plate, respectively; analyzing, by the processor, the first and second images included in the target image; and determining a mismatch between coating properties of the first coating material on the first surface of the electrode plate and coating properties of the second coating material on the second surface of the electrode plate.

According to still another aspect of the present disclosure, there is provided an apparatus for analyzing a coated state of an electrode plate of a secondary battery, with a first coating material and a second coating material being located on first and second surfaces of the electrode plate, respectively. The apparatus includes: a first marker generation module disposed on a first side of an electrode plate; a first image acquisition module that is disposed on the first side of the electrode plate and acquires a first target image including an image of a first area of the first surface and an image of a first area of the second surface, respectively, wherein markers generated by the first marker generation module are respectively overlaid on the first area of the first surface and the first area of the second surface of the electrode plate, and the first coating material and the second coating material are located on the first and second surfaces of the electrode plate, respectively; a second marker generation module disposed on a second side of the electrode plate; a second image acquisition module that is disposed on the second side of the electrode plate and acquires a second target image including an image of a second area of the first surface and an image of a second area of the second surface, respectively, wherein markers generated by the second marker generation module are overlaid on the second area of the first surface and the second area of the second surface of the electrode plate; and a processor, wherein the processor is configured to: i) determine a mismatch between coating properties of the first coating material in the first area of the first surface of the electrode plate and coating properties of the second coating material in the first area of the second surface of the electrode plate by analyzing the first target image using the markers on the first target image, ii) determine a mismatch between the coating properties of the first coating material in the second area of the first surface of the electrode plate and the coating properties of the second coating material in the second area of the second surface of the electrode plate by analyzing the second target image using the markers on the second target image, iii) determine a mismatch between the coating properties of the first coating material in the first area of the first surface of the electrode plate and the coating properties of the first coating material in the second area of the first surface of the electrode plate using the markers on the first and second target images, or iv) determine a mismatch between the coating properties of the second coating material in the first area of the second surface of the electrode plate and the coating properties of the second coating material in the second area of the second surface of the electrode plate using the markers on the first and second target images.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is an exemplary diagram illustrating an electrode manufacturing process to which an apparatus for analyzing a coated state of an electrode plate of a secondary battery according to embodiments of the present disclosure is applied;

FIG. 2 is an exemplary diagram illustrating an electrode plate applied to an apparatus for analyzing a coated state of an electrode plate of a secondary battery according to embodiments of the present disclosure;

FIG. 3 is a block diagram illustrating an apparatus for analyzing a coated state of an electrode plate of a secondary battery according to embodiments of the present disclosure;

FIGS. 4 and 5 are exemplary diagrams illustrating an arrangement structure of a marker generation module and an image acquisition module according to embodiments of the present disclosure;

FIGS. 6 to 8 are exemplary diagrams illustrating results of markers being overlaid on first to third surfaces of the electrode plate by the marker generation module according to embodiments of the present disclosure;

FIGS. 9 to 12 are exemplary diagrams illustrating target images acquired by the image acquisition module according to the embodiments of the present disclosure;

FIG. 13 is a block diagram illustrating an apparatus for analyzing a coated state of an electrode plate of a secondary battery according to embodiments of the present disclosure;

FIGS. 14 and 15 are exemplary diagrams illustrating an arrangement structure of first and second marker generation modules and first and second image acquisition modules according to embodiments of the present disclosure;

FIGS. 16 to 21 are exemplary diagrams illustrating results of markers being overlaid on first to fourth surfaces of the electrode plate by the first and second marker generation modules according to embodiments of the present disclosure;

FIGS. 22 and 23 are exemplary diagrams illustrating first and second target images acquired by the first and second image acquisition modules according to embodiments of the present disclosure;

FIG. 24 is a flowchart illustrating a method of analyzing the coated state of the electrode plate of the secondary battery according to embodiments of the present disclosure; and

FIG. 25 is a flowchart illustrating a method of analyzing the coated state of the electrode plate of the secondary battery according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

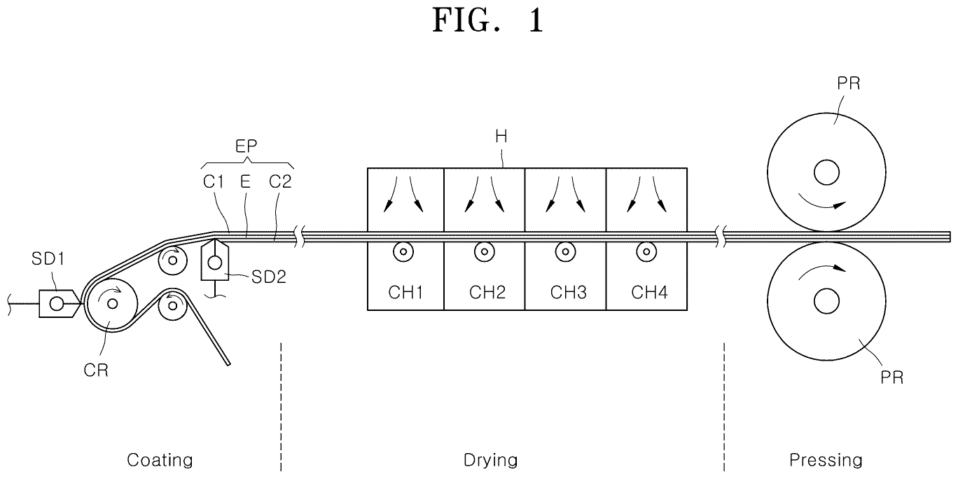

FIG. 1 is an exemplary diagram illustrating an electrode manufacturing process to which an apparatus for analyzing a coated state of an electrode plate of a secondary battery according to embodiments of the present disclosure is applied. A coating process, a drying process, and a rolling process, which are prerequisites for implementing the present embodiment will be generally described with reference to FIG. 1.

When a coating material (a mixture of an active material, a conductive material, and a binder) with which an electrode current collector E (an aluminum substrate or a copper substrate) will be coated by a mixing process is provided, the coating material is discharged onto each of a first surface (e.g., an upper surface) and a second surface (e.g., a lower surface) of the electrode current collector E through first and second slot dies SD1 and SD2 during a process in which the electrode current collector E is transferred by the rotation of a coating roll CR, so that the electrode current collector E is coated with the coating material in a specific pattern and with a uniform thickness.

Thereafter, a drying process is performed on the coating material in order to remove a solvent contained in the coating material of an electrode plate EP, and a temperature and wind speed of hot air are gradually adjusted in a stepwise manner during a process in which the electrode plate EP passes through an interior of a dryer (a heating oven) H composed of a plurality of chambers CH1 to CH4, so that the coating material is dried, a liquid component of the coating material is removed, and only a solid electrode layer is maintained on the electrode current collector E.

The rolling process consists of a roll-to-roll process in which the electrode plate EP is unwound from an unwinder (not illustrated) and wound around a rewinder (not illustrated). The electrode plate EP coated with the coating material is unwound from the unwinder, and foreign substances on the electrode plate EP are removed by a brush member or an airflow member. Thereafter, the electrode plate EP is rolled by rolling rolls PR, the foreign substances on the electrode plate EP are removed by the brush member or the airflow member, and then the electrode plate EP is wound around the rewinder. In the rolling process, a thickness of the electrode plate EP coated with the coating material is reduced to a predefined target thickness according to the manufacturing specifications of a secondary battery, and, accordingly, a thickness of the coating material becomes uniform, a bonding force between the electrode current collector E and the coating material is improved, and finally energy density (energy density per unit volume) of the second battery is increased.

In order to secure the performance of the secondary battery (e.g., energy density, capacity, etc.) according to the design specifications, a coating material with which the first surface of the electrode current collector E is coated and a coating material with which the second surface is coated should be aligned and coated in corresponding areas of the first surface and the second surface of the electrode current collector E (i.e., the coating materials located in upper and lower directions of the electrode current collector E should have a symmetrical structure), and should have the same thickness. Present embodiments present mechanisms for detecting a mismatch between the coating properties of first and second coating materials C1 and C2 with which the first and second surfaces of the electrode current collector E, respectively, are coated. Processes of analyzing a coated state of an electrode plate of the present embodiments to be described below may be performed before the rolling process is performed after the coating process and the drying process are completed, or may be performed after the rolling process is completed.

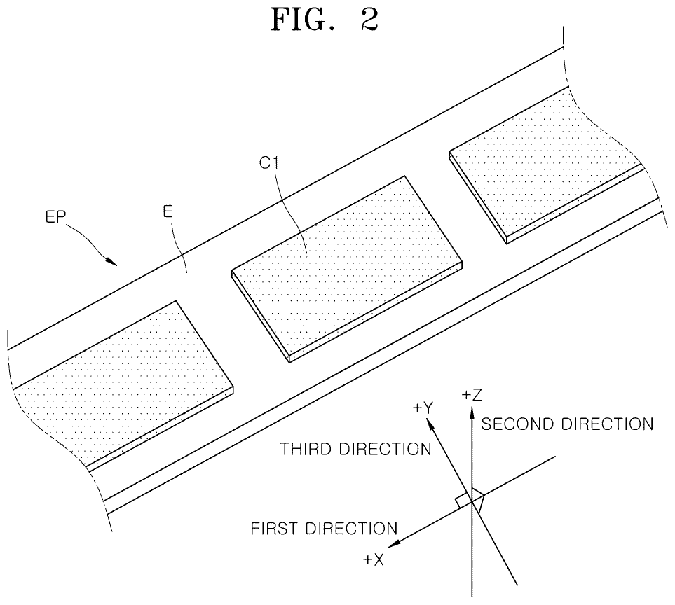

FIG. 2 is an exemplary diagram illustrating an electrode plate applied to an apparatus for analyzing a coated state of an electrode plate of a secondary battery according to embodiments of the present disclosure.

In order to aid understanding of the embodiment, as illustrated in FIG. 2, a transfer direction of an electrode plate EP is defined as a first direction (a +X-axis direction), a direction in which an electrode current collector E is coated with coating materials and stacked is defined as a second direction (a +Z-axis direction), and a width direction of the electrode plate EP (or an optical axis direction of an image recognition sensor 111 to be described below) is defined as a third direction (a +Y-axis direction).

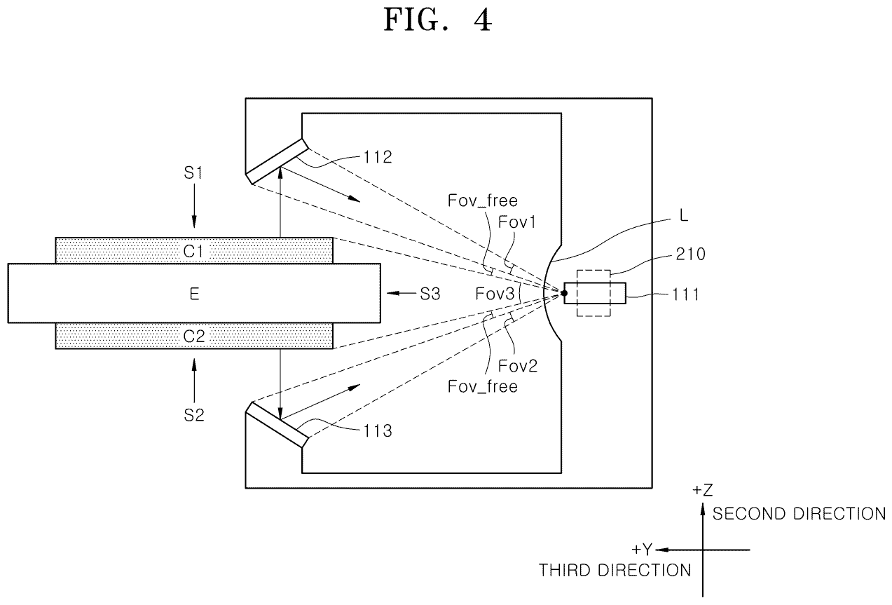

Further, the electrode plate EP to be described below is defined to have a structure in which the electrode current collector E is coated with the coating materials. First and second surfaces S1 and S2 of the electrode plate EP may correspond to one surface and a surface opposite thereto of the electrode plate EP based on the second direction, and for example, the first surface S1 may correspond to an upper surface of the electrode plate EP and the second surface S2 may correspond to a lower surface of the electrode plate EP (see, i.e., FIG. 4, described below). A first coating material C1 may be located on the first surface S1 of the electrode plate EP, and a second coating material C2 may be located on the second surface S2 of the electrode plate EP (see, i.e., FIG. 4, described below). A third surface S3 of the electrode plate EP may correspond to a side surface of the electrode plate EP based on the third direction (see, i.e., FIG. 4, described below). Each of the first to third surfaces, S1 to S3, may refer to a portion of each surface.

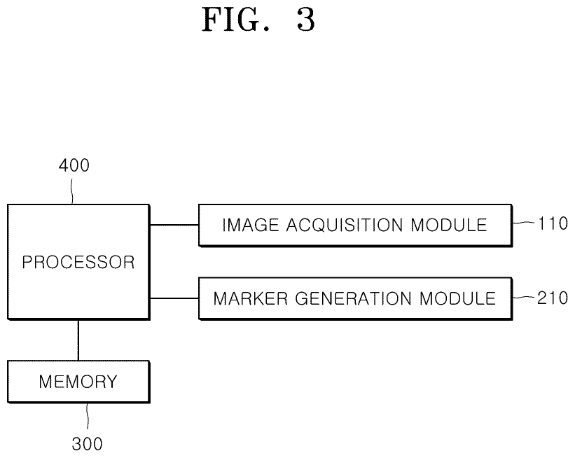

FIG. 3 is a block diagram illustrating an apparatus for analyzing a coated state of an electrode plate of a secondary battery according to embodiments of the present disclosure.

The apparatus for analyzing the coated state of the electrode plate of the secondary battery according some embodiments may include an image acquisition module 110, a marker generation module 210, a memory 300, and a processor 400.

The image acquisition module 110 may be disposed on a first side (based on the third direction) of the electrode plate EP being transferred during an electrode manufacturing process and may be configured to acquire a target image to be analyzed in order to detect a mismatch of the coating properties of the coating materials (as will be described below), and the target image may be configured to include first to third images, IMG1 to IMG3, for each of the first to third surfaces, S1 to S3, of the electrode plate EP. The operation of the image acquisition module 110 may be controlled by the processor 400, described below.

In order to enable the target image to be composed of the first to third images, IMG1 to IMG3, for each of the first to third surfaces, S1 to S3, of the electrode plate EP, the image acquisition module 110 may include an image recognition sensor 111, a first mirror 112, and a second mirror 113.

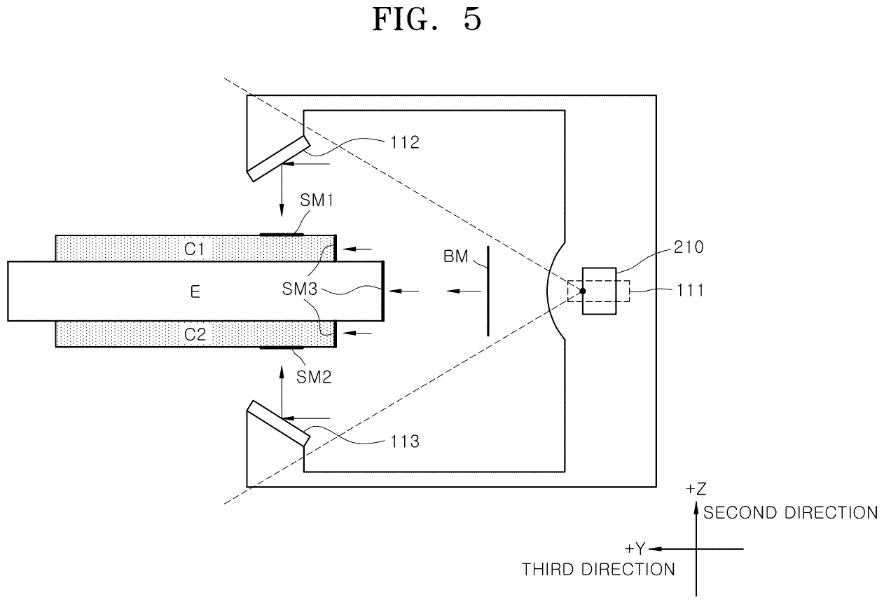

FIGS. 4 and 5 are exemplary diagrams illustrating an arrangement structure of a marker generation module and an image acquisition module according to embodiments of the present disclosure.

Referring to FIG. 4, the image recognition sensor 111 may be disposed to be spaced apart from the third surface S3 of the electrode plate EP based on the third direction, and an optical axis of the image recognition sensor 111 may be configured to be formed at the same position (i.e., the same height) as the electrode plate EP based on the second direction. The image recognition sensor 111 may be implemented as a conventional camera sensor.

The first mirror 112 may be disposed to be spaced apart from the first surface S1 of the electrode plate EP based on the second direction (a +Z-axis direction) and may be configured to reflect light incident from the first surface S1 of the electrode plate EP to the image recognition sensor 111. To this end, the first mirror 112 may be configured to form a pre-designed angle (e.g., 45°) with a straight line extending from the first surface S1 in the second direction.

The second mirror 113 may be disposed to be spaced apart from the second surface S2 of the electrode plate EP based on the second direction and may be configured to reflect light incident from the second surface S2 of the electrode plate EP to the image recognition sensor 111. To this end, the second mirror 113 may be configured to form a pre-designed angle (e.g., 45°) with a straight line extending from the second surface S2 in the second direction (specifically, in an opposite direction to the second direction based on FIG. 4).

The first and second mirrors 112 and 113 may be disposed symmetrically with respect to the optical axis of the image recognition sensor 111. That is, a distance between the first mirror 112 and the electrode plate EP and a distance between the second mirror 113 and the electrode plate EP may have the same value.

The image recognition sensor 111 may have a pre-designed field of view (FOV) in order to acquire the first to third images, IMG1 to IMG3, corresponding to the first to third surfaces, S1 to S3, of the electrode plate EP, respectively. As illustrated in FIG. 4, a first FOV FOV1 may be configured to cover the first mirror 112, a second FOV FOV2 may be configured to cover the second mirror 113, and a third FOV FOV3 may be configured to cover the third surface S3 of the electrode plate EP. Accordingly, the first mirror 112 located within the first FOV FOV1 may be captured as an image by the image recognition sensor 111 so that the first image IMG1 may be acquired, the second mirror 113 located within the second FOV FOV2 may be captured as an image by the image recognition sensor 111 so that the second image IMG2 may be acquired, and the third surface S3 of the electrode plate EP located within the third FOV FOV3 may be captured as an image by the image recognition sensor 111 so that the third image IMG3 may be acquired.

Since the FOV of the image recognition sensor 111 includes the first to third FOVs, FOV1 to FOV3, a target image captured by the image recognition sensor 111 may be configured to include the first to third images, IMG1 to IMG3. (A mechanical structure of the image acquisition module 110 may be designed so that an area corresponding to a free space on the target image is not included, and when a free space is present on the target image, the images corresponding to two FOVs FOV_{free} that cover the free space may be removed by the processor 400 to be described below.) It should be noted that the target image is not formed by combining the first to third images, IMG1 to IMG3, that are acquired separately, but rather the target image is acquired through a single capture of the image recognition sensor 111 and is configured to be divided into the first to third images, IMG1 to IMG3, according to the first to third FOVs, FOV1 to FOV3.

A frame and housing of an appropriate structure may be provided on the first side of the electrode plate EP to support the image recognition sensor 111 and the first and second mirrors 112 and 113.

The marker generation module 210 may be configured to generate a marker that serves as a criterion for determining a mismatch of the coating properties of the first and second coating materials C1 and C2 to be described below and may be implemented to have a structure of being integrated into an inside or outside of the frame and housing of the image acquisition module 110. A marker generated by the marker generation module 210 may be configured to be transmitted through a lens optical system L of the image recognition sensor 111 and applied toward the electrode plate EP. An optical axis of the marker generation module 210 may be configured to be identical to the optical axis of the image recognition sensor 111, and to this end, an optical structure of applying the marker generated by the marker generation module 210 toward the electrode plate EP without interfering with the image recognition sensor 111 may be provided within the frame and housing of the image acquisition module 110. As another embodiment, the optical axis of the marker generation module 210 and the optical axis of the image recognition sensor 111 may be configured to be parallel to each other in the third direction and to be spaced a pre-defined distance from each other in the first direction, and, accordingly, the marker generated by the marker generation module 210 may be applied toward the electrode plate EP without interfering with the image recognition sensor 111. The operation of the marker generation module 210 may be controlled by the processor 400.

The marker may correspond to a line-shaped laser (i.e., a line laser), and, accordingly, the marker generation module 210 may be implemented as a line laser generator, which generates a line laser and applies the generated line laser toward the electrode plate EP. The marker generation module 210 may apply a line laser having the second direction as a longitudinal direction thereof as a marker toward the electrode plate EP. The line laser may be applied toward the electrode plate EP in a state of being parallel to the second direction and is not applied obliquely in the first direction, which provides a basis for determining a positional mismatch of the first and second coating materials C1 and C2 based on the marker on the target image, as will be described below. The markers and sub-markers to be described below each refer to a line laser.

Referring to FIG. 5, when the marker that is generated by the marker generation module 210 and applied toward the electrode plate EP is defined as a base marker BM, a portion of the base marker BM may be reflected by the first mirror 112 onto the first surface S1 of the electrode plate EP, and, accordingly, the base marker BM partially reflected by the first mirror 112 may be overlaid on the first surface S1 of the electrode plate EP.

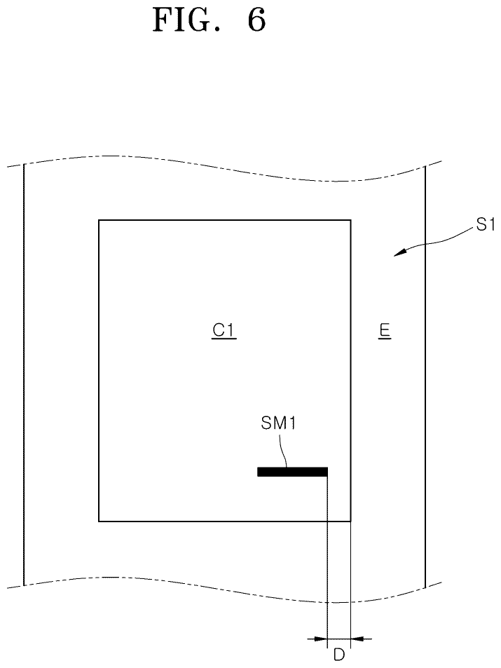

FIGS. 6 to 8 are exemplary diagrams illustrating results of markers being overlaid on first to third surfaces of the electrode plate by the marker generation module according to embodiments of the present disclosure.

The marker overlaid on the first surface S1 of the electrode plate EP is defined as a first sub-marker SM1 (see FIG. 6).

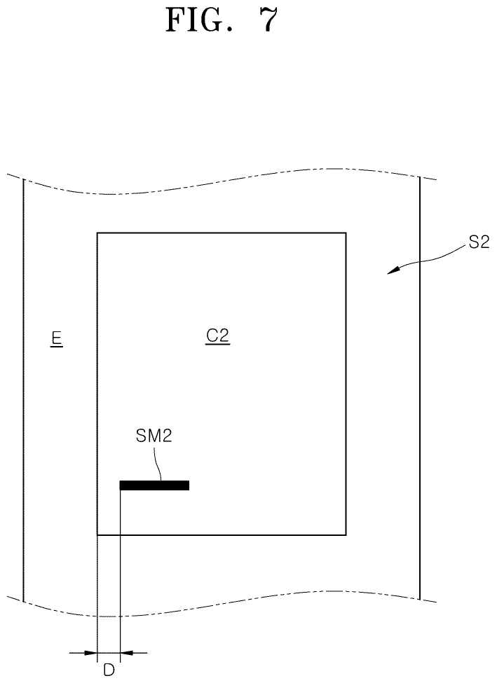

Further, a portion of the base marker BM may be reflected by the second mirror 113 onto the second surface S2 of the electrode plate EP, and, accordingly, the base marker BM partially reflected by the second mirror 113 may be overlaid on the second surface S2 of the electrode plate EP. The marker overlaid on the second surface S2 of the electrode plate EP is defined as a second sub-marker SM2 (see FIG. 7).

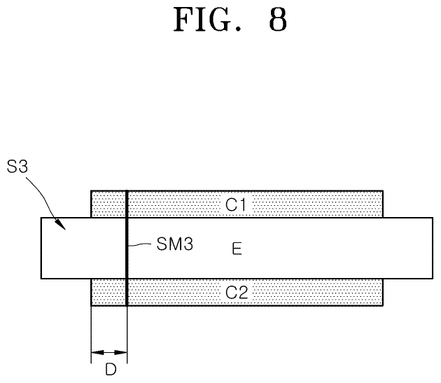

Further, a portion of the base marker BM may be directly applied to the third surface S3 of the electrode plate EP and overlaid on the third surface S3. The marker overlaid on the third surface S3 of the electrode plate EP is defined as a third sub-marker SM3 (see FIG. 8).

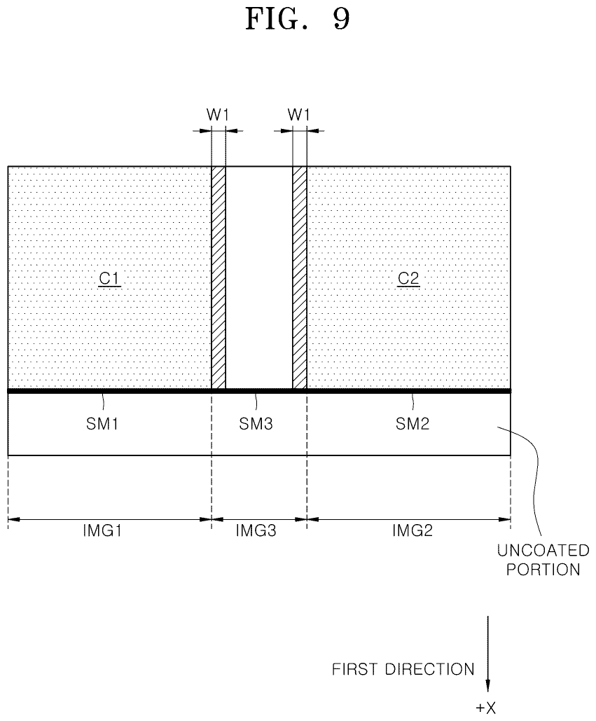

FIGS. 9 to 12 are exemplary diagrams illustrating target images acquired by the image acquisition module according to embodiments of the present disclosure.

The image acquisition module 110 described above may be configured to acquire a target image including the first to third images, IMG1 to IMG3, for each of the first to third surfaces, S1 to S3, in a state in which the marker generated by the marker generation module 210 is overlaid on the first to third surfaces, S1 to S3, of the electrode plate EP, respectively. That is, in a state in which the first to third sub-markers, SM1 to SM3, are overlaid on the first to third surfaces, S1 to S3, of the electrode plate EP, respectively, the image recognition sensor 111 of the image acquisition module 110 may image an area corresponding to the FOV thereof to acquire the target image. Since the first and second mirrors 112 and 113 are disposed symmetrically with respect to the optical axis of the image recognition sensor 111 in the second direction and the first to third sub-markers, SM1 to SM3, are formed by being derived from the same line laser (i.e., the base marker BM), as illustrated in FIGS. 9 to 12, the first to third sub-markers, SM1 to SM3, may be configured as continuous lines on the target image, and the continuous lines may function as analysis criteria for the first and second images IMG1 and IMG2 on the target image (as will be described below).

At least one command executed by the processor 400 may be stored in the memory 300. Further, in some embodiments, a first algorithm for controlling the marker generation module 210 and the image acquisition module 110 to be linked, a second algorithm for detecting a positional mismatch and thickness mismatch between the first and second coating materials C1 and C2, and a conventional image processing algorithm for supporting the second algorithm may be stored in the memory 300. The memory 300 may be implemented as a volatile storage medium and/or a non-volatile storage medium, and may be implemented as, for example, a read-only memory (ROM) and/or a random access memory (RAM).

The processor 400 is a subject that performs an operation of detecting a positional mismatch and thickness mismatch between the first and second coating materials C1 and C2 to be described below, may be implemented as a central processing unit (CPU) or a system on chip (SoC), control a plurality of hardware or software components by driving an operating system or application, and perform various types of data processing and operations. The processor 400 may be configured to execute at least one command stored in the memory 300 and store result data of the execution in the memory 300. The processor 400 may be implemented as a programmable logic controller (PLC) for controlling manufacturing equipment (e.g., a slot die, a dryer, a plate transfer conveyor, a winder, an unwinder, etc.) provided for an electrode manufacturing process.

The processor 400 may analyze the first and second images IMG1 and IMG2 included in the target image using the marker on the target image that is acquired by the image acquisition module 110 and determine a mismatch between the coating properties of the first coating material C1 on the first surface S1 of the electrode plate EP and the coating properties of the second coating material C2 on the second surface S2 of the electrode plate EP. Here, the coating properties of the coating material may include a position of the coating material on the surface of the electrode plate EP. That is, the processor 400 may determine whether a position of the first coating material C1 on the first surface S1 and a position of the second coating material C2 on the second surface S2 are aligned with respect to the first direction.

Specifically, the processor 400 may determine the positional mismatch between the first and second coating materials C1 and C2 using the first and second sub-markers SM1 and SM2 composed of continuous lines on the target image. In this case, the processor 400 may determine that there is a positional mismatch between the first and second coating materials C1 and C2 when a distance between the first sub-marker SM1 and the first coating material C1 is different from a distance between the second sub-marker SM2 and the second coating material C2 on the target image.

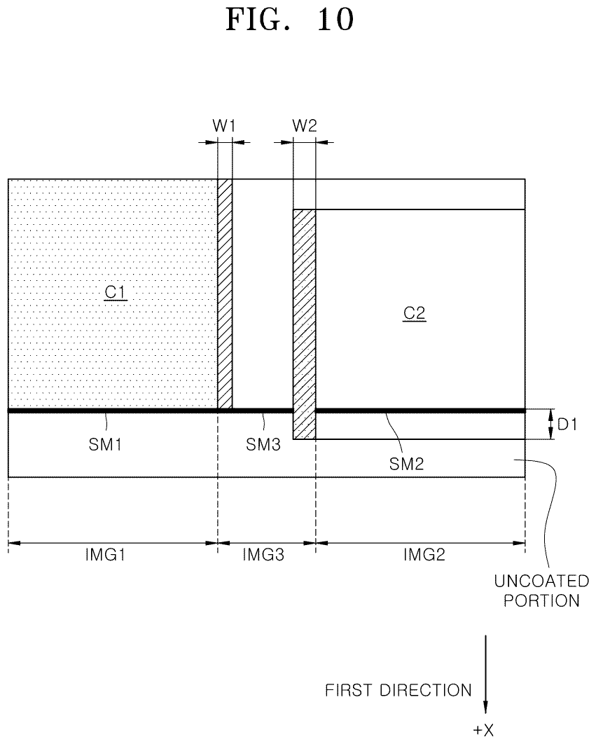

FIGS. 9 and 10 illustrate examples of target images acquired by the image acquisition module 110 in a state in which the first to third sub-markers, SM1 to SM3, are overlaid on the first to third surfaces, S1 to S3, of the electrode plate EP, respectively, when a coating pattern of the electrode plate EP corresponds to an intermittent pattern. (The target images of FIGS. 9 and 10 are acquired at a time point when the first sub-marker SM1 is overlaid on a first direction edge of the first coating material C1 located on the first surface S1 of the electrode plate EP.)

Referring to FIG. 9, a distance between the first direction edge of the first coating material C1 and the first sub-marker SM1 and a distance between a first direction edge of the second coating material C2 and the second sub-marker SM2 both have a value of 0 (which corresponds to a state in which the first and second sub-markers SM1 and SM2 overlap the first direction edge of the first coating material C1 and the first direction edge of the second coating material C2, respectively). In this case, the processor 400 may determine that the position of the first coating material C1 on the first surface S1 and the position of the second coating material C2 on the second surface S2 are aligned with respect to the first direction.

Referring to FIG. 10, the distance between the first direction edge of the first coating material C1 and the first sub-marker SM1 has a value of 0, and the distance between the first direction edge of the second coating material C2 and the second sub-marker SM2 has a value of “D1.” In this case, since the distance between the first coating material C1 and the first sub-marker SM1 is different from the distance between the second coating material C2 and the second sub-marker SM2 on the target image, the processor 400 may determine that there is a positional mismatch between the first and second coating materials C1 and C2 (i.e., the processor 400 may determine that the position of the first coating material C1 on the first surface S1 and the position of the second coating material C2 on the second surface S2 are not aligned with respect to the first direction).

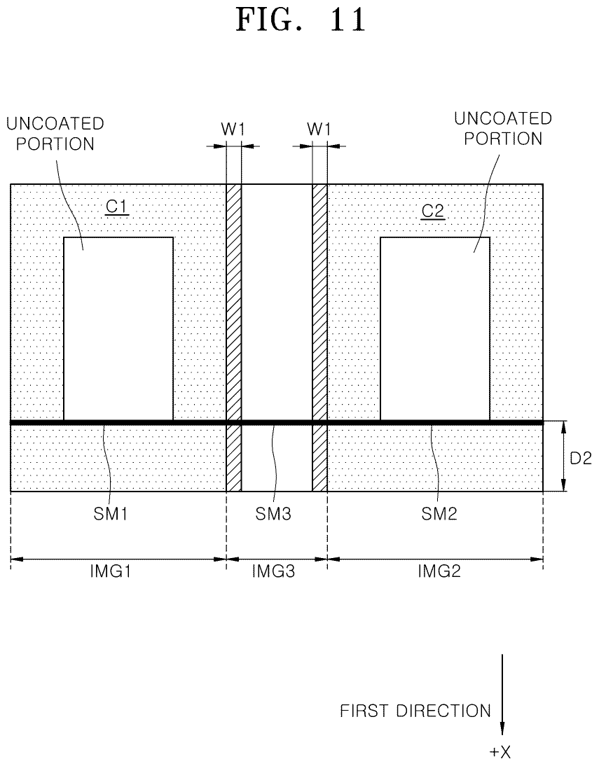

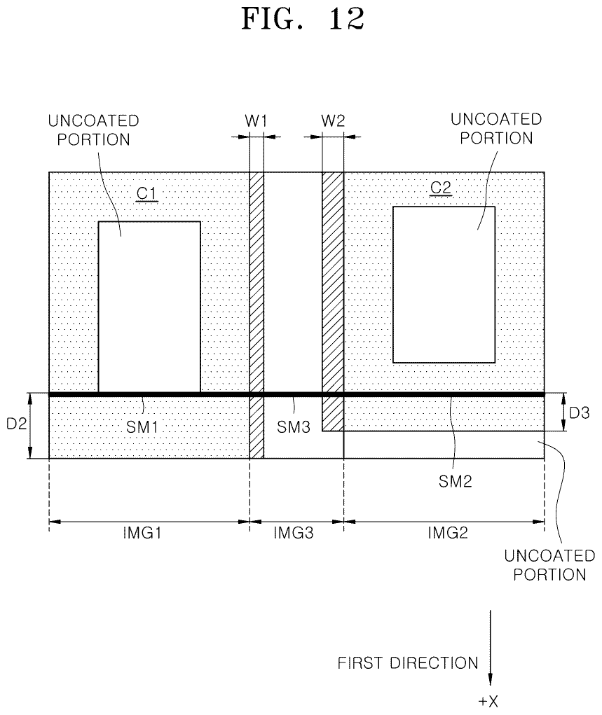

FIGS. 11 and 12 illustrate examples of target images acquired by the image acquisition module 110 in a state in which the first to third sub-markers, SM1 to SM3, are overlaid on the first to third surfaces, S1 to S3, of the electrode plate EP, respectively, when a coating pattern of the electrode plate EP corresponds to a stripe pattern according to laser ablation. (The target images of FIGS. 11 and 12 are acquired at a time point when the first sub-marker SM1 overlaps and is overlaid on the first direction edge of an uncoated portion exposed according to laser ablation.)

Referring to FIG. 11, the distance between the first direction edge of the first coating material C1 and the first sub-marker SM1 and the distance between the first direction edge of the second coating material C2 and the second sub-marker SM2 both have a value of “D2.” In this case, the processor 400 may determine that the position of the first coating material C1 on the first surface S1 and the position of the second coating material C2 on the second surface S2 are aligned with respect to the first direction.

Referring to FIG. 12, the distance between the first direction edge of the first coating material C1 and the first sub-marker SM1 has a value of “D2,” and the distance between the first direction edge of the second coating material C2 and the second sub-marker SM2 has a value of “D3.” In this case, since the distance between the first coating material C1 and the first sub-marker SM1 is different from the distance between the second coating material C2 and the second sub-marker SM2 on the target image, the processor 400 may determine that there is a positional mismatch between the first and second coating materials C1 and C2 (i.e., the processor 400 may determine that the position of the first coating material C1 on the first surface S1 and the position of the second coating material C2 on the second surface S2 are not aligned with respect to the first direction).

The coating properties of the coating material may further include the thickness of the coating material on the surface of the electrode plate EP. Accordingly, the processor 400 may analyze the third image IMG3 on the target image and determine whether a thickness of the first coating material C1 on the first surface S1 and a thickness of the second coating material C2 on the second surface S2 are identical.

In the examples of FIGS. 9 and 11, the thickness of the first coating material C1 and the thickness of the second coating material C2 both have a value of “W1.” On the other hand, in the examples of FIGS. 10 and 12, the thickness of the first coating material C1 has a value of “W1,” and the thickness of the second coating material C2 has a value of “W2.” In the cases of FIGS. 10 and 12, since the thickness of the first coating material C1 is different from the thickness of the second coating material C2 on the target image, the processor 400 may determine that there is a thickness mismatch between the first and second coating materials C1 and C2.

In some embodiments, using a single laser system and a vision system located on one side of an electrode plate transfer device, the positional mismatch and thickness mismatch between an upper coating material (the first coating material C1) and a lower coating material (the second coating material C2) with which the upper surface (the first surface S1) and the lower surface (the second surface S2) of the electrode current collector E are respectively coated by the coating process may be accurately and easily detected.

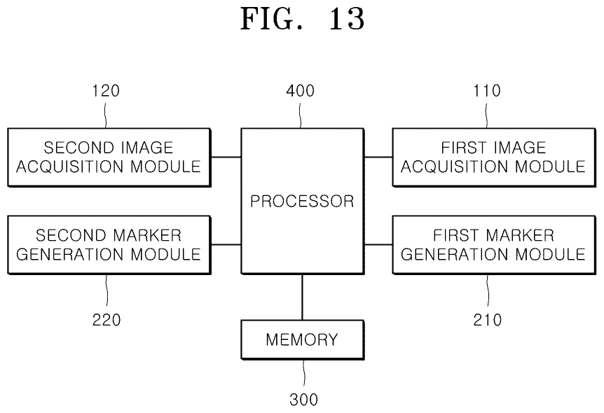

FIG. 13 is a block diagram illustrating an apparatus for analyzing a coated state of an electrode plate of a secondary battery according to some embodiments of the present disclosure.

In some embodiments, a duplex structure in which the marker generation module and the image acquisition module of the above-described embodiment(s) are disposed on both sides of an electrode plate EP that is transferred during the electrode manufacturing process is presented, and based on this duplex structure, in addition to the mismatch between the coating properties of the first coating material C1 of the first surface S1 and the coating properties of the second coating material C2 of the second surface S2 that is determined, as described above, a configuration for determining a coating direction mismatch and a thickness mismatch formed in each area of a first coating material C1 located on a first surface S1 and a coating direction mismatch and a thickness mismatch formed in each area of a second coating material C2 located on a second surface S2 is provided.

Referring to FIG. 13, the apparatus for analyzing the coated state of the electrode plate of the secondary battery in some embodiments may include a first image acquisition module 110, a first marker generation module 210, a second image acquisition module 120, a second marker generation module 220, a memory 300, and a processor 400.

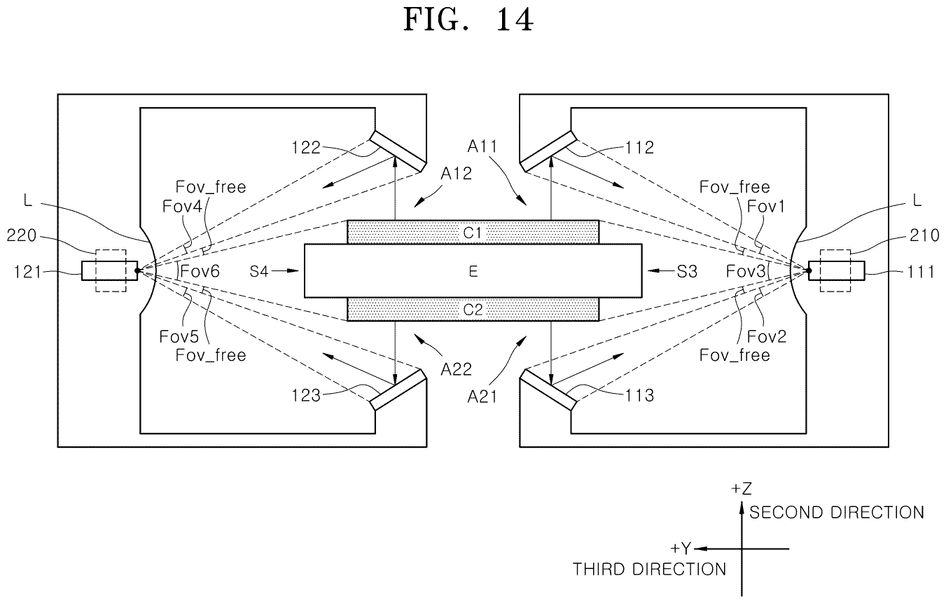

The first image acquisition module 110 may be disposed on the first side (based on the third direction) of the electrode plate EP being transferred during an electrode manufacturing process and may be configured to acquire a first target image, and the first target image may be configured to include a first image IMG1 for a first area A11 (see FIG. 14) of the first surface S1 of the electrode plate EP, a second image IMG2 for a first area A21 (see FIG. 14) of the second surface S2 of the electrode plate EP, and a third image IMG3 for the third surface S3 of the electrode plate EP. The operation of the first image acquisition module 110 may be controlled by the processor 400.

In order to enable the first target image to be composed of the first image IMG1 for the first area A11 of the first surface S1, the second image IMG2 for the first area A21 of the second surface S2 of the electrode plate EP, and the third image IMG3 for the third surface S3 of the electrode plate EP, the first image acquisition module 110 may include a first image recognition sensor 111, a first mirror 112, and a second mirror 113.

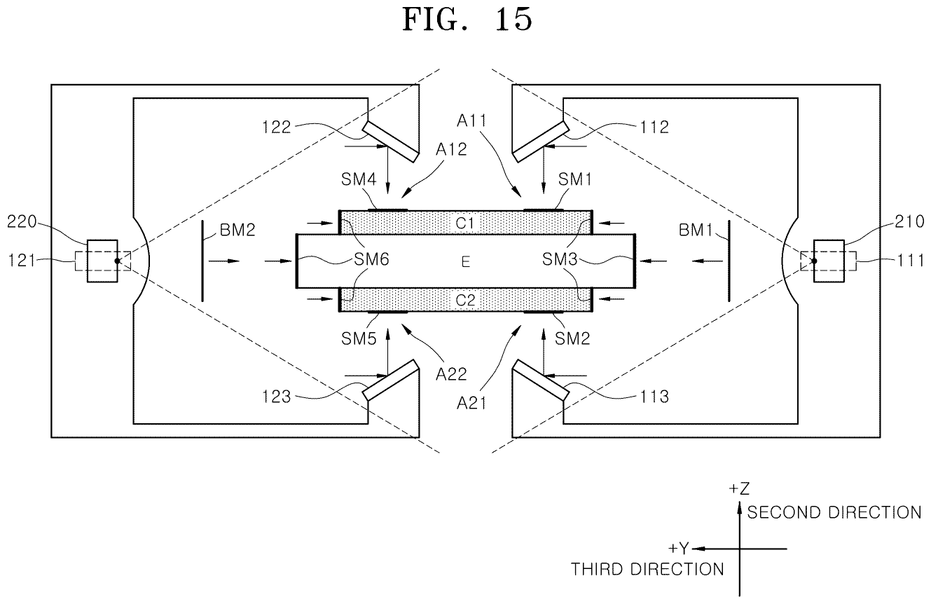

FIGS. 14 and 15 are exemplary diagrams illustrating an arrangement structure of first and second marker generation modules and first and second image acquisition modules according to some embodiments of the present disclosure.

The first to third directions, as described above at least for FIG. 2, are equally applied to FIGS. 14 and 15. Further, the first and second surfaces, S1 and S2, of the electrode plate EP may correspond to one surface and a surface opposite thereto of the electrode plate EP based on the second direction, and for example, the first surface S1 may correspond to an upper surface of the electrode plate EP, and the second surface S2 may correspond to a lower surface of the electrode plate EP. The first coating material C1 may be located on the first surface S1 of the electrode plate EP, and the second coating material C2 may be located on the second surface S2 of the electrode plate EP. A third surface S3 of the electrode plate EP may correspond to a side surface corresponding to a first side of the electrode plate EP based on the third direction, and a fourth surface S4 may correspond to a side surface corresponding to a second side (a side opposite to the first side) of the electrode plate EP based on the third direction.

Referring to FIG. 14, the first image recognition sensor 111 may be disposed to be spaced apart from the third surface S3 of the electrode plate EP based on the third direction, and an optical axis of the first image recognition sensor 111 may be configured to be formed at the same position (i.e., the same height) as the electrode plate EP based on the second direction. The first image recognition sensor 111 may be implemented as a conventional camera sensor.

The first mirror 112 may be disposed to be spaced apart from the first surface S1 of the electrode plate EP based on the second direction (a +Z-axis direction), and may be configured to reflect light incident from the first area A11 of the first surface S1 of the electrode plate EP to the first image recognition sensor 111. To this end, the first mirror 112 may be configured to form a pre-designed angle (e.g., 45°) with a straight line extending from the first area A11 of the first surface S1 in the second direction.

The second mirror 113 may be disposed to be spaced apart from the second surface S2 of the electrode plate EP based on the second direction and may be configured to reflect light incident from the first area A21 of the second surface S2 of the electrode plate EP to the first image recognition sensor 111. To this end, the second mirror 113 may be configured to form a pre-designed angle (e.g., 45°) with a straight line extending from the first area A21 of the second surface S2 in the second direction (specifically, in an opposite direction to the second direction based on FIG. 14).

The first and second mirrors 112 and 113 may be disposed symmetrically with respect to the optical axis of the first image recognition sensor 111. That is, a distance between the first mirror 112 and the electrode plate EP and a distance between the second mirror 113 and the electrode plate EP may have the same value.

The first image recognition sensor 111 may have a pre-designed FOV in order to acquire the first image IMG1 corresponding to the first area A11 of the first surface S1 of the electrode plate EP, the second image IMG2 corresponding to the first area A21 of the second surface S2 of the electrode plate EP, and the third image IMG3 corresponding to the third surface S3 of the electrode plate EP. As illustrated in FIG. 14, a first FOV FOV1 may be configured to cover the first mirror 112, a second FOV FOV2 may be configured to cover the second mirror 113, and a third FOV FOV3 may be configured to cover the third surface S3 of the electrode plate EP. Accordingly, the first mirror 112 located within the first FOV FOV1 may be captured as an image by the first image recognition sensor 111 so that the first image IMG1 may be acquired, the second mirror 113 located within the second FOV FOV2 may be captured as an image by the first image recognition sensor 111 so that the second image IMG2 may be acquired, and the third surface S3 of the electrode plate EP located within the third FOV FOV3 may be captured as an image by the first image recognition sensor 111 so that the third image IMG3 may be acquired.

Since the FOV of the first image recognition sensor 111 includes the first to third FOVs, FOV1 to FOV3, a first target image captured by the first image recognition sensor 111 may be configured to include the first to third images, IMG1 to IMG3. (A mechanical structure of the first image acquisition module 110 may be designed so that an area corresponding to a free space on the first target image is not included, and when a free space is present on the first target image, the images corresponding to two FOVs FOV_{free} that cover the free space may be removed by the processor 400.) It should be noted that the first target image is not formed by combining the first to third images, IMG1 to IMG3, that are acquired separately, but rather the first target image is acquired through a single capture of the first image recognition sensor 111 and is configured to be divided into the first to third images, IMG1 to IMG3, according to the first to third FOVs, FOV1 to FOV3.

A frame and housing of an appropriate structure may be provided on the first side of the electrode plate EP to support the first image recognition sensor 111 and the first and second mirrors 112 and 113.

The first marker generation module 210 may be configured to generate a marker that serves as a criterion for determining a mismatch of the coating properties of the first and second coating materials C1 and C2 and may be implemented to have a structure of being integrated into an inside or outside of the frame and housing of the first image acquisition module 110. The marker generated by the first marker generation module 210 may be configured to be transmitted through a lens optical system L of the first image recognition sensor 111 and applied toward the electrode plate EP. An optical axis of the first marker generation module 210 may be configured to be identical to the optical axis of the first image recognition sensor 111, and to this end, an optical structure of applying the marker generated by the first marker generation module 210 toward the electrode plate EP without interfering with the first image recognition sensor 111 may be provided within the frame and housing of the first image acquisition module 110. As another embodiment, the optical axis of the first marker generation module 210 and the optical axis of the first image recognition sensor 111 may be configured to be parallel to each other in the third direction and to be spaced a pre-defined distance from each other in the first direction, and, accordingly, the marker generated by the first marker generation module 210 may be applied toward the electrode plate EP without interfering with the first image recognition sensor 111. The operation of the first marker generation module 210 may be controlled by the processor 400.

The marker generated by the first marker generation module 210 may correspond to a line-shaped laser (i.e., a line laser), and, accordingly, the first marker generation module 210 may be implemented as a line laser generator that generates a line laser and applies the generated line laser toward the electrode plate EP. The first marker generation module 210 may apply a line laser having the second direction as a longitudinal direction thereof as a marker toward the electrode plate EP. The line laser may be applied toward the electrode plate EP in a state of being parallel to the second direction and is not applied obliquely in the first direction. This provides a basis for determining a positional mismatch of the first and second coating materials C1 and C2 based on the marker on the first target image. The markers and sub-markers to be described below each refer to a line laser.

Referring to FIG. 15, when the marker that is generated by the first marker generation module 210 and applied toward the electrode plate EP is defined as a first base marker BM1, a portion of the first base marker BM1 may be reflected by the first mirror 112 onto the first area A11 of the first surface S1 of the electrode plate EP, and, accordingly, the first base marker BM1 partially reflected by the first mirror 112 may be overlaid on the first area A11 of the first surface S1 of the electrode plate EP.

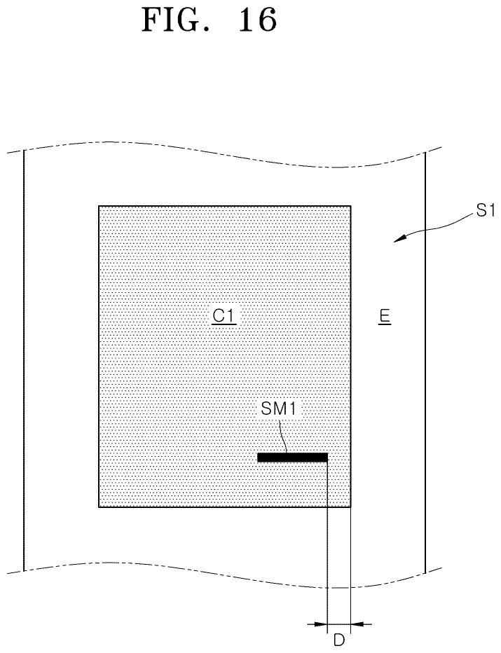

FIGS. 16 to 21 are exemplary diagrams illustrating results of markers being overlaid on first to fourth surfaces of the electrode plate by the first and second marker generation modules according to some embodiments of the present disclosure.

The marker overlaid on the first area A11 of the first surface S1 of the electrode plate EP is defined as a first sub-marker SM1 (see FIG. 16).

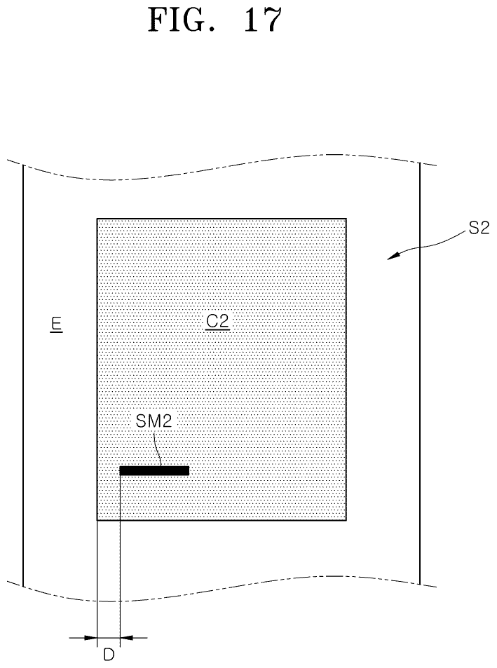

Further, a portion of the first base marker BM1 may be reflected by the second mirror 113 onto the first area A21 of the second surface S2 of the electrode plate EP, and, accordingly, the first base marker BM1 partially reflected by the second mirror 113 may be overlaid on the first area A21 of the second surface S2 of the electrode plate EP. The marker overlaid on the first area A21 of the second surface S2 of the electrode plate EP is defined as a second sub-marker SM2 (see FIG. 17).

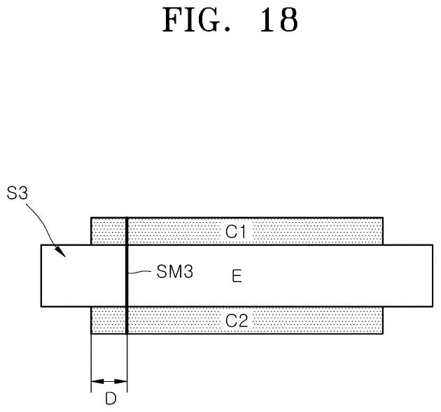

Further, a portion of the first base marker BM1 may be directly applied to the third surface S3 of the electrode plate EP and overlaid on the third surface S3. The marker overlaid on the third surface S3 of the electrode plate EP is defined as a third sub-marker SM3 (see FIG. 18).

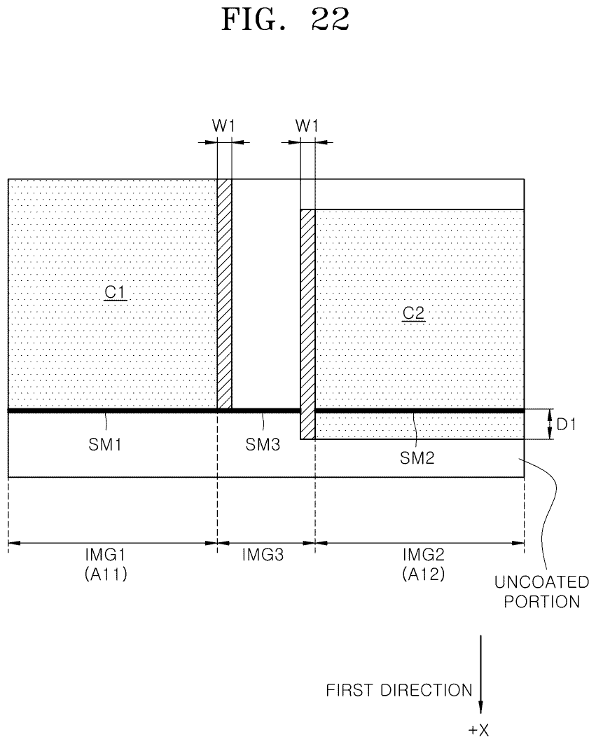

Referring back to FIGS. 14 and 15, the first image acquisition module 110 described above may be configured to acquire a first target image including the first to third images, IMG1 to IMG3, for each of the first to third surfaces, S1 to S3, in a state in which the marker generated by the first marker generation module 210 is overlaid on each of the first area A11 of the first surface S1, the first area A21 of the second surface S2, and the third surface S3 of the electrode plate EP. That is, in a state in which the first to third sub-markers, SM1 to SM3, are overlaid on the first area A11 of the first surface S1 of the electrode plate EP, the first area A21 of the second surface S2, and the third surface S3, respectively, the first image recognition sensor 111 of the first image acquisition module 110 may image an area corresponding to the FOV thereof to acquire the first target image. Since the first and second mirrors 112 and 113 are disposed symmetrically with respect to the optical axis of the first image recognition sensor 111 in the second direction and the first to third sub-markers, SM1 to SM3, are formed by being derived from the same line laser (i.e., the first base marker BM1), as illustrated in FIG. 22 (discussed below), the first to third sub-markers, SM1 to SM3, may be configured as continuous lines on the first target image, and the continuous lines may function as analysis criteria for the first and second images IMG1 and IMG2 on the first target image (as will be described below).

The second image acquisition module 120 may be disposed on the second side of the electrode plate EP (based on the third direction) being transferred during an electrode manufacturing process and may be configured to acquire a second target image, and the second target image may be configured to include a fourth image IMG4 for a second area A12 of the first surface S1 of the electrode plate EP, a fifth image IMG5 for a second area A22 of the second surface S2 of the electrode plate EP, and a sixth image IMG6 for the fourth surface S4 of the electrode plate EP. The operation of the second image acquisition module 120 may be controlled by the processor 400.

In order to enable the second target image to be composed of the fourth image IMG4 for the second area A12 of the first surface S1, the fifth image IMG5 for the second area A22 of the second surface S2 of the electrode plate EP, and the sixth image IMG6 for the fourth surface S4 of the electrode plate EP, the second image acquisition module 120 may include a second image recognition sensor 121, a third mirror 122, and a fourth mirror 123.

Referring back to FIG. 14 in particular, the second image recognition sensor 121 may be disposed to be spaced apart from the fourth surface S4 of the electrode plate EP based on the third direction, and an optical axis of the second image recognition sensor 121 may be configured to be formed at the same position (i.e., the same height) as the electrode plate EP based on the second direction. The second image recognition sensor 121 may be implemented as a conventional camera sensor.

The third mirror 122 may be disposed to be spaced apart from the first surface S1 of the electrode plate EP based on the second direction (the +Z-axis direction) and may be configured to reflect light incident from the second area A12 of the first surface S1 of the electrode plate EP to the second image recognition sensor 121. To this end, the third mirror 122 may be configured to form a pre-designed angle (e.g., 45°) with a straight line extending from the second area A12 of the first surface S1 in the second direction.

The fourth mirror 123 may be disposed to be spaced apart from the second surface S2 of the electrode plate EP based on the second direction and may be configured to reflect light incident from the second area A22 of the second surface S2 of the electrode plate EP to the second image recognition sensor 121. To this end, the fourth mirror 123 may be configured to form a pre-designed angle (e.g., 45°) with a straight line extending from the second area A22 of the second surface S2 in the second direction (specifically, in the opposite direction to the second direction based on FIG. 14).

The third and fourth mirrors 122 and 123 may be disposed symmetrically with respect to the optical axis of the second image recognition sensor 121. That is, a distance between the third mirror 122 and the electrode plate EP and a distance between the fourth mirror 123 and the electrode plate EP may have the same value.

The second image recognition sensor 121 may have a pre-designed FOV in order to acquire the fourth image IMG4 corresponding to the second area A12 of the first surface S1 of the electrode plate EP, the fifth image IMG5 corresponding to the second area A22 of the second surface S2 of the electrode plate EP, and the sixth image IMG6 corresponding to the fourth surface S4 of the electrode plate EP. As illustrated in FIG. 14, a fourth FOV FOV4 may be configured to cover the third mirror 122, a fifth FOV FOV5 may be configured to cover the fourth mirror 123, and a sixth FOV FOV6 may be configured to cover the fourth surface S4 of the electrode plate EP. Accordingly, the third mirror 122 located within the fourth FOV FOV4 may be captured as an image by the second image recognition sensor 121 so that the fourth image IMG4 may be acquired, the fourth mirror 123 located within the fifth FOV FOV5 may be captured as an image by the second image recognition sensor 121 so that the fifth image IMG5 may be acquired, and the fourth surface S4 of the electrode plate EP located within the sixth FOV FOV6 may be captured as an image by the second image recognition sensor 121 so that the sixth image IMG6 may be acquired.

Since the FOV of the second image recognition sensor 121 includes the fourth to sixth FOVs, FOV4 to FOV6, a second target image captured by the second image recognition sensor 121 may be configured to include the fourth to sixth images, IMG4 to IMG6. (A mechanical structure of the second image acquisition module 120 may be designed so that an area corresponding to a free space on the second target image is not included, and when a free space is present on the second target image, the images corresponding to two FOVs FOV_{free} that cover the free space may be removed by the processor 400.) It should be noted that the second target image is not formed by combining the fourth to sixth images, IMG4 to IMG6, that are acquired separately, but rather the second target image is acquired through a single capture of the second image recognition sensor 121 and is configured to be divided into the fourth to sixth images, IMG4 to IMG6, according to the fourth to sixth FOVs, FOV4 to FOV6.

A frame and housing of an appropriate structure may be provided on the second side of the electrode plate EP to support the second image recognition sensor 121 and the third and fourth mirrors 122 and 123.

The second marker generation module 220 may be configured to generate a marker that serves as a criterion for determining a mismatch of the coating properties of the first and second coating materials C1 and C2 and may be implemented to have a structure of being integrated into an inside or outside of the frame and housing of the second image acquisition module 120. A marker generated by the second marker generation module 220 may be configured to be transmitted through a lens optical system L of the second image recognition sensor 121 and applied toward the electrode plate EP. An optical axis of the second marker generation module 220 may be configured to be identical to the optical axis of the second image recognition sensor 121, and to this end, an optical structure of applying the marker generated by the second marker generation module 220 toward the electrode plate EP without interfering with the second image recognition sensor 121 may be provided within the frame and housing of the second image acquisition module 120. As another embodiment, the optical axis of the second marker generation module 220 and the optical axis of the second image recognition sensor 121 may be configured to be parallel to each other in the third direction and to be spaced a pre-defined distance from each other in the first direction, and, accordingly, the marker generated by the second marker generation module 220 may be applied toward the electrode plate EP without interfering with the second image recognition sensor 121. The operation of the second marker generation module 220 may be controlled by the processor 400.

The marker generated by the second marker generation module 220 may correspond to a line-shaped laser (i.e., a line laser), and, accordingly, the second marker generation module 220 may be implemented as a line laser generator that generates a line laser and applies the generated line laser toward the electrode plate EP. The second marker generation module 220 may apply a line laser having the second direction as a longitudinal direction thereof as a marker toward the electrode plate EP. The line laser may be applied toward the electrode plate EP in a state of being parallel to the second direction and is not applied obliquely in the first direction. This provides a basis for determining a positional mismatch of the first and second coating materials C1 and C2 based on the marker on the second target image. The markers and sub-markers to be described below each refer to a line laser.

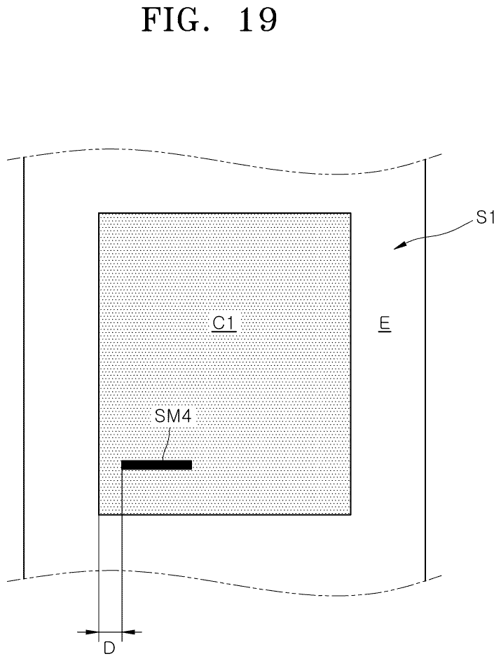

Referring to FIG. 15, when the marker that is generated by the second marker generation module 220 and applied toward the electrode plate EP is defined as a second base marker BM2, a portion of the second base marker BM2 may be reflected by the third mirror 122 onto the second area A12 of the first surface S1 of the electrode plate EP, and, accordingly, the second base marker BM2 partially reflected by the third mirror 122 may be overlaid on the second area A12 of the first surface S1 of the electrode plate EP. The marker overlaid on the second area A12 of the first surface S1 of the electrode plate EP is defined as a fourth sub-marker SM4 (see FIG. 19).

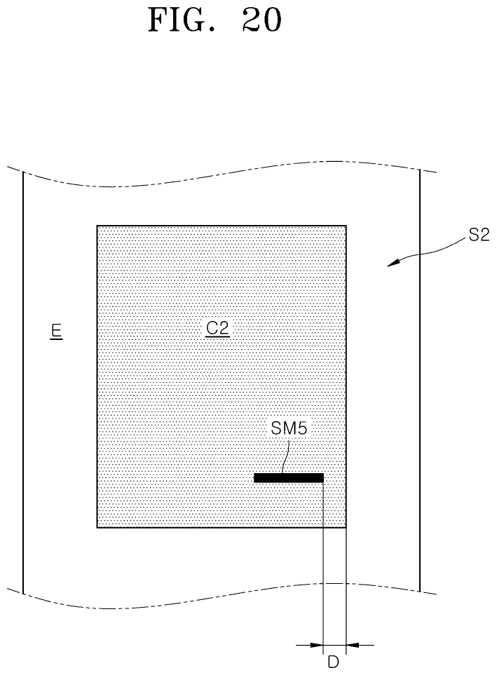

Further, a portion of the second base marker BM2 may be reflected by the fourth mirror 123 onto the second area A22 of the second surface S2 of the electrode plate EP, and, accordingly, the second base marker BM2 partially reflected by the fourth mirror 123 may be overlaid on the second area A22 of the second surface S2 of the electrode plate EP. The marker overlaid on the second area A22 of the second surface S2 of the electrode plate EP is defined as a fifth sub-marker SM5 (see FIG. 20).

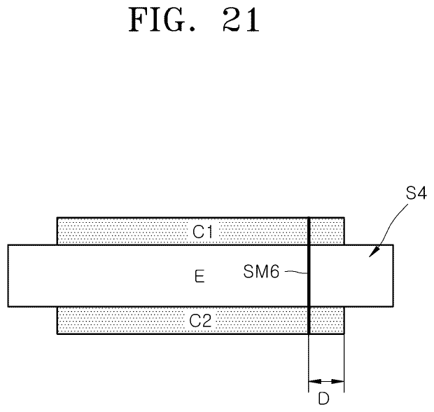

Further, a portion of the second base marker BM2 may be directly applied to the fourth surface S4 of the electrode plate EP and overlaid on the fourth surface S4. The marker overlaid on the fourth surface S4 of the electrode plate EP is defined as a sixth sub-marker SM6 (see FIG. 21).

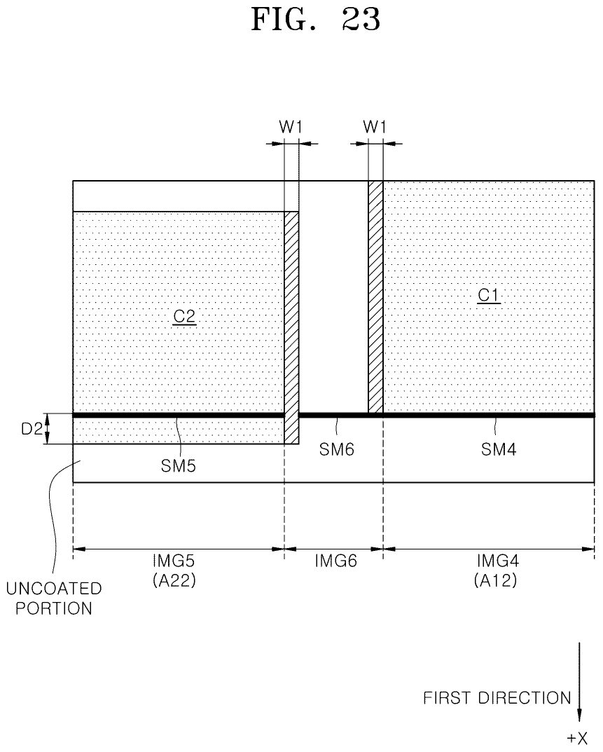

The second image acquisition module 120 described above may be configured to acquire a second target image including fourth to sixth images, IMG4 to IMG6, for each of the first surface S1, the second surface S2, and the fourth surface S4 in a state in which markers generated by the second marker generation module 220 are overlaid on each of the second area A12 of the first surface S1 of the electrode plate EP, the second area A22 of the second surface S2, and the fourth surface S4. That is, in a state in which the fourth to sixth sub-markers, SM4 to SM6, are overlaid on each of the second area A12 of the first surface S1 of the electrode plate EP, the second area A22 of the second surface S2, and the fourth surface S4, the second image recognition sensor 121 of the second image acquisition module 120 may image an area corresponding to the FOV thereof to acquire the second target image. Since the third and fourth mirrors 122 and 123 are disposed symmetrically with respect to the optical axis of the second image recognition sensor 121 in the second direction and the fourth to sixth sub-markers, SM4 to SM6, are formed by being derived from the same line laser (i.e., the second base marker BM2), as illustrated in FIG. 23 (discussed below), the fourth to sixth sub-markers, SM4 to SM6, may be configured as continuous lines on the second target image, and the continuous lines may function as analysis criteria for the first and second images IMG1 and IMG2 on the second target image (as will be described below).

As described above, the first image acquisition module 110 and the second image acquisition module 120 may be respectively disposed on the first side and the second side of the electrode plate EP and may be disposed symmetrically with respect to the first direction as an axis (i.e., may be disposed symmetrically with respect to the +X-axis). Similarly, the first marker generation module 210 and the second marker generation module 220 may be respectively disposed on the first side and the second side of the electrode plate EP and may be disposed symmetrically with respect to the first direction as an axis. Therefore, the marker on the first target image that is generated by the first image acquisition module 110 and the marker on the second target image that is generated by the second image acquisition module 120 may have the same position value based on the first direction (i.e., have the same X coordinate in a three-axis coordinate system), which may provide a basis for detecting a coating direction mismatch formed in each area of the first coating material C1 and a coating direction mismatch formed in each area of the second coating material C2.

At least one command executed by the processor 400 may be stored in the memory 300. Further, a first algorithm for controlling the first and second marker generation modules 210 and 220 and the first and second image acquisition modules 110 and 120 to be linked, a second algorithm for detecting a positional mismatch and thickness mismatch between the first and second coating materials C1 and C2, a third algorithm for detecting a coating direction mismatch and thickness mismatch formed in each area of the first and second coating materials C1 and C2, and a conventional image processing algorithm for supporting the second and third algorithms may be stored in the memory 300. The memory 300 may be implemented as a volatile storage medium and/or a non-volatile storage medium, and may be implemented as, for example, a ROM and/or a RAM.

The processor 400 is a subject that performs an operation of detecting the positional mismatch and thickness mismatch between the first and second coating materials C1 and C2 and performs an operation of detecting the coating direction mismatch and thickness mismatch formed in each area of the first and second coating materials C1 and C2. The processor 400 may be implemented as a CPU or a SoC. Further, the processor 400 may control a plurality of hardware or software components by driving an operating system or application and may perform various types of data processing and operations. The processor 400 may be configured to execute at least one command stored in the memory 300 and may store result data of the execution in the memory 300. The processor 400 may be implemented as a PLC for controlling manufacturing equipment (e.g., a slot die, a dryer, a plate transfer conveyor, a winder, an unwinder, etc.) provided for an electrode manufacturing process.

The processor 400 may analyze the first and second images IMG1 and IMG2 included in the first target image using the marker on the first target image that is acquired by the first image acquisition module 110 and may determine a mismatch between the coating properties of the first coating material C1 on the first area A11 of the first surface S1 of the electrode plate EP and the coating properties of the second coating material C2 on the first area A21 of the second surface S2 of the electrode plate EP. That is, the processor 400 may determine whether the position of the first coating material C1 on the first area A11 of the first surface S1 and the position of the second coating material C2 on the first area A21 of the second surface S2 are aligned with respect to the first direction. Specifically, the processor 400 may determine the positional mismatch between the first and second coating materials C1 and C2 using the first and second sub-markers SM1 and SM2 composed of continuous lines on the first target image. In this case, the processor 400 may determine that there is a positional mismatch between the first and second coating materials C1 and C2 when a distance between the first coating material C1 and the first sub-marker SM1 is different from a distance between the second coating material C2 and the second sub-marker SM2 on the first target image. Further, the processor 400 may analyze the third image IMG3 of the first target image and determine that there is a thickness mismatch between the first and second coating materials C1 and C2 when the thickness of the first coating material C1 on the first area A11 of the first surface S1 is different from the thickness of the second coating material C2 on the first area A21 of the second surface S2.

The processor 400 may analyze the fourth and fifth images, IMG4 and IMG5, included in the second target image using the marker on the second target image that is acquired by the second image acquisition module 120 and determine a mismatch between the coating properties of the first coating material C1 on the second area A12 of the first surface S1 of the electrode plate EP and the coating properties of the second coating material C2 on the second area A22 of the second surface S2 of the electrode plate EP. That is, the processor 400 may determine whether the position of the first coating material C1 on the second area A12 of the first surface S1 and the position of the second coating material C2 on the second area A22 of the second surface S2 are aligned with respect to the first direction. Specifically, the processor 400 may determine the positional mismatch between the first and second coating materials C1 and C2 using the fourth and fifth sub-markers, SM4 and SM5, composed of continuous lines on the second target image. In this case, the processor 400 may determine that there is a positional mismatch between the first and second coating materials C1 and C2 when a distance between the first coating material C1 and the fourth sub-marker SM4 is different from a distance between the second coating material C2 and the fifth sub-marker SM5 on the second target image. Further, the processor 400 may analyze the sixth image IMG6 of the second target image and determine that there is a thickness mismatch between the first and second coating materials C1 and C2 when the thickness of the first coating material C1 on the second area A12 of the first surface S1 is different from the thickness of the second coating material C2 on the second area A22 of the second surface S2.

In relation to determining the coating direction mismatch and thickness mismatch formed in each area of the first and second coating materials C1 and C2, the processor 400 may determine the mismatch between the coating properties of the first coating material C1 on the first area A11 of the first surface S1 of the electrode plate EP and the coating properties of the first coating material C1 on the second area A12 of the first surface S1 of the electrode plate EP using the marker on the first and second target images. Here, the coating properties of the coating material may include the coating direction of the coating material on the surface of the electrode plate EP. That is, the processor 400 may determine whether the position of the first coating material C1 on the first area A11 of the first surface S1 and the position of the first coating material C1 on the second area A12 of the first surface S1 are aligned with respect to the first direction.

Specifically, the processor 400 may determine that there is a coating direction mismatch of the first coating material C1 according to each area of the first surface S1 when the distance between the marker (i.e., the first sub-marker SM1) overlaid on the first area A11 of the first surface S1 of the electrode plate EP and the first coating material C1 on the first target image is different from the distance between the marker (i.e., the fourth sub-marker SM4) overlaid on the second area A12 of the first surface S1 of the electrode plate EP and the first coating material C1 on the second target image. That is, when the first direction position (X-axis coordinate in the three-axis coordinate system) of the first coating material C1 located on the first surface S1 of the electrode plate EP is different in the first area A11 and the second area A12, it may mean that the electrode current collector E is inclined in the coating process (e.g., top-coating process) (e.g., the electrode current collector E is inclined, and the first coating material C1 between the first area A11 and the second area A12 of the first surface S1 is obliquely coated), and therefore, in this case, the processor 400 may determine that there is a mismatch in the coating direction (i.e., a coating direction mismatch) in each area of the first coating material C1 located on the first surface S1.

Further, the processor 400 may determine the mismatch between the coating properties of the second coating material C2 on the first area A21 of the second surface S2 of the electrode plate EP and the coating properties of the second coating material C2 on the second area A22 of the second surface S2 of the electrode plate EP using the marker on the first and second target images. That is, the processor 400 may determine whether the position of the second coating material C2 on the first area A21 of the second surface S2 and the position of the second coating material C2 on the second area A22 of the second surface S2 are aligned with respect to the first direction.

Specifically, the processor 400 may determine that there is the coating direction mismatch of the second coating material C2 according to each area of the second surface S2 when the distance between the marker (i.e., the second sub-marker SM2) overlaid on the first area A21 of the second surface S2 of the electrode plate EP and the second coating material C2 on the first target image is different from the distance between the marker (i.e., the fifth sub-marker SM5) overlaid on the second area A22 of the second surface S2 of the electrode plate EP and the second coating material C2 on the second target image. That is, when the first direction position (X-axis coordinate in the three-axis coordinate system) of the second coating material C2 located on the second surface S2 of the electrode plate EP is different in the first area A21 and the second area A22, it may mean that the electrode current collector E is inclined in the coating process (e.g., back-coating process) (e.g., the electrode current collector E is inclined and the second coating material C2 between the first area A21 and the second area A22 of the second surface S2 is obliquely coated), and therefore, in this case, the processor 400 may determine that there is a mismatch in the coating direction (i.e., a coating direction mismatch) in each area of the second coating material C2 located on the second surface S2.

The coating properties of the coating material may further include the thickness of the coating material on the surface of the electrode plate EP. Accordingly, the processor 400 may determine that there is a thickness mismatch of the first coating material C1 for each area of the first surface S1 when a width of the first coating material C1 on the third image IMG3 of the first target image is different from a width of the first coating material C1 on the sixth image IMG6 of the second target image. Further, the processor 400 may determine that there is a thickness mismatch of the second coating material C2 for each area of the second surface S2 when a width of the second coating material C2 on the third image IMG3 of the first target image is different from a width of the second coating material C2 on the sixth image IMG6 of the second target image.

FIGS. 22 and 23 are exemplary diagrams illustrating first and second target images acquired by the first and second image acquisition modules, respectively, according to some embodiments of the present disclosure.

Referring to FIG. 22, a distance between a first direction edge of the first coating material C1 and the first sub-marker SM1 in the first area A11 of the first surface S1 has a value of 0, and a distance between a first direction edge of the second coating material C2 and the second sub-marker SM2 in the first area A21 of the second surface S2 has a value of “D1.” In this case, the processor 400 may determine that there is a mismatch between a position of the first coating material C1 in the first area A11 of the first surface S1 and a position of the second coating material C2 in the first area A21 of the second surface S2 (i.e., the processor 400 may determine that the position of the first coating material C1 in the first area A11 of the first surface S1 and the position of the second coating material C2 in the first area A21 of the second surface S2 are not aligned with respect to the first direction). Further, in FIG. 22, since the thickness of the first coating material C1 and the thickness of the second coating material C2 both have a value of “W1,” the processor 400 may determine that there is no thickness mismatch between the first and second coating materials C1 and C2.

Referring to FIG. 23, a distance between the first direction edge of the first coating material C1 and the fourth sub-marker SM4 in the second area A12 of the first surface S1 has a value of 0, and the distance between the first direction edge of the second coating material C2 and the fifth sub-marker SM5 in the second area A22 of the second surface S2 has a value of “D2.” In this case, the processor 400 may determine that there is a mismatch between the position of the first coating material C1 in the second area A12 of the first surface S1 and the position of the second coating material C2 in the second area A22 of the second surface S2 (i.e., the processor 400 may determine that the position of the first coating material C1 in the second area A12 of the first surface S1 and the position of the second coating material C2 in the second area A22 of the second surface S2 are not aligned with respect to the first direction). Further, in FIG. 23, since the thickness of the first coating material C1 and the thickness of the second coating material C2 both have a value of “W1,” the processor 400 may determine that there is no thickness mismatch between the first and second coating materials C1 and C2.

Referring to FIGS. 22 and 23, since the distance between the first direction edge of the first coating material C1 and the first sub-marker SM1 in the first area A11 of the first surface S1 on the first target image and the distance between the first direction edge of the first coating material C1 and the fourth sub-marker SM4 in the second area A12 of the first surface S1 on the second target image both have a value of 0, the processor 400 may determine that there is no the coating direction mismatch in each area of the first coating material C1 located on the first surface S1. Further, in FIGS. 22 and 23, since the thickness of the first coating material C1 in the first area A11 of the first surface S1 and the thickness of the first coating material C1 in the second area A12 of the first surface S1 both have a value of “W1,” the processor 400 may determine that there is no thickness mismatch in each area of the first coating material C1 located on the first surface S1.

Since the distance between the first direction edge of the second coating material C2 and the second sub-marker SM2 in the first area A21 of the second surface S2 on the first target image has a value of “D1” and the distance between the first direction edge of the second coating material C2 and the fifth sub-marker SM5 in the second area A22 of the second surface S2 on the second target image has a value of “D2,” the processor 400 may determine that there is the coating direction mismatch in each area of the second coating material C2 located on the second surface S2 (e.g., the processor 400 may determine that the electrode current collector E is inclined and the second coating material C2 between the first area A21 of the second surface S2 and the second area A22 is obliquely coated). Further, since the thickness of the second coating material C2 in the first area A21 of the second surface S2 and the thickness of the second coating material C2 in the second area A22 of the second surface S2 both have a value of “W1,” the processor 400 may determine that there is no thickness mismatch in each area of the second coating material C2 located on the second surface S2.

In some embodiments, using a dual laser system and vision system disposed on both sides of an electrode plate transfer device, the positional mismatch and thickness mismatch between the upper coating material (the first coating material C1) and the lower coating material (the second coating material C2), the coating direction mismatch and thickness mismatch formed in each area of the upper coating material, and the coating direction mismatch and thickness mismatch formed in each area of the lower coating material may be accurately and easily detected.

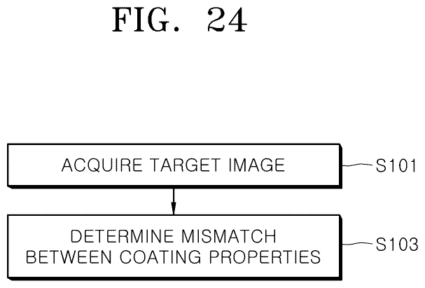

FIG. 24 is a flowchart illustrating a method of analyzing the coated state of the electrode plate of the secondary battery according to embodiments of the present disclosure. Descriptions that would be identical to that of the above-described content will be omitted, and the description of FIG. 24 will focus on a time-series configuration.

The processor 400 acquires a target image through the image acquisition module 110 (S101). The target image includes first to third images, IMG1 to IMG3, to which first to third sub-markers, SM1 to SM3, are respectively reflected. The first image IMG1 corresponds to the first surface S1 of the electrode plate EP, the second image IMG2 corresponds to the second surface S2 of the electrode plate EP, and the third image IMG3 corresponds to the third surface S3 of the electrode plate EP.

The processor 400 analyzes the first and second images IMG1 and IMG2 included in the target image and determines a mismatch between the coating properties of the first coating material C1 on the first surface S1 of the electrode plate EP and the coating properties of the second coating material C2 on the second surface S2 of the electrode plate EP (S103).

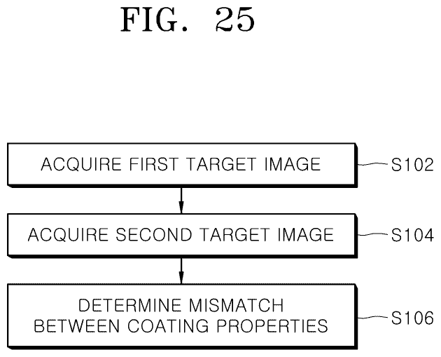

FIG. 25 is a flowchart illustrating a method of analyzing the coated state of the electrode plate of the secondary battery according to some embodiments of the present disclosure. Descriptions that would be identical to that of the above-described content will be omitted, and the description of FIG. 25 will focus on a time-series configuration.

The processor 400 acquires a first target image through the first image acquisition module 110 (S102). The first target image includes first to third images, IMG1 to IMG3, to which first to third sub-markers, SM1 to SM3, are respectively reflected. The first image IMG1 corresponds to the first area A11 of the first surface S1 of the electrode plate EP, the second image IMG2 corresponds to the first area A21 of the second surface S2 of the electrode plate EP, and the third image IMG3 corresponds to the third surface S3 of the electrode plate EP.

Then, the processor 400 acquires a second target image through the second image acquisition module 120 (S104). The second target image includes fourth to sixth images, IMG4 to IMG6, to which fourth to sixth sub-markers, SM4 to SM6, are respectively reflected. The fourth image IMG4 corresponds to the second area A12 of the first surface S1 of the electrode plate EP, the fifth image IMG5 corresponds to the second area A22 of the second surface S2 of the electrode plate EP, and the sixth image IMG6 corresponds to the fourth surface S4 of the electrode plate EP.

Operations S102 and S104 are parallel operations that are performed independently, and their execution order is not limited to the order described above.

When the first and second target images are acquired through operations S102 and S104, the processor 400 i) analyzes the first target image using a marker on the first target image and determines a mismatch between the coating properties of the first coating material C1 on the first area A11 of the first surface S1 of the electrode plate EP and the coating properties of the second coating material C2 on the first area A21 of the second surface S2 of the electrode plate EP, ii) analyzes the second target image using a marker on the second target image and determines a mismatch between the coating properties of the first coating material C1 on the second area A12 of the first surface S1 of the electrode plate EP and the coating properties of the second coating material C2 on the second area A22 of the second surface S2 of the electrode plate EP, iii) determines a mismatch between the coating properties of the first coating material C1 on the first area A11 of the first surface S1 of the electrode plate EP and the coating properties of the first coating material C1 on the second area A12 of the first surface S1 of the electrode plate EP using the markers on the first and second target images, or iv) determines a mismatch between the coating properties of the second coating material C2 on the first area A21 of the second surface S2 of the electrode plate EP and the coating properties of the second coating material C2 on the second area A22 of the second surface S2 of the electrode plate EP using the markers on the first and second target images (S106). For an accurate analysis of the coated state of the electrode plate EP, all of the above processes i) to iv) may be performed in operation S106.

The term “module” used herein may include a unit composed of hardware, software, or firmware and, for example, may be used interchangeably with a term such as logic, a logic block, a component, or a circuit. The module may be an integrally constituted part or a minimum unit or a part thereof that performs one or more functions. For example, the module may be implemented as an application-specific integrated circuit (ASIC). Further, the implementation described herein may be conducted, for example, as a method, a process, a device, a software program, a data stream, or a signal. Even when discussed only in the context of a single form of implementation (e.g., discussed only as a method), the implementation of the discussed features may also be conducted in other forms (e.g., as a device or program). The device may be implemented by appropriate hardware, software, firmware, etc. The method may be implemented in a device such as a processor, which generally refers to a processing device, such as a computer, a microprocessor, an integrated circuit, a programmable logic device, etc. The processor further includes a communication device, such as a computer, a cellular phone, a personal digital assistant (PDA), and other devices that facilitate communication of information between end-users.

According to the present disclosure, using a single laser system and a vision system located on one side of an electrode plate transfer device, a positional mismatch and a thickness mismatch between an upper coating material and a lower coating material, with which an upper surface and a lower surface of an electrode current collector are respectively coated by a coating process, can be accurately and easily detected.

Further, according to the present disclosure, using a dual laser system and a vision system disposed on both sides of an electrode plate transfer device, a positional mismatch and a thickness mismatch between an upper coating material and a lower coating material, a coating direction mismatch and thickness mismatch formed in each area of the upper coating material, and a coating direction mismatch and thickness mismatch formed in each area of the lower coating material can be accurately and easily detected.

However, effects that can be achieved through the present disclosure are not limited to the above-described effects and other effects that are not described may be clearly understood by those skilled in the art from the detailed descriptions.

Although the present disclosure has been described with reference to embodiments and drawings illustrating aspects thereof, the present disclosure is not limited thereto. Various modifications and variations can be made by a person skilled in the art.

What is claimed is:

1. An apparatus for analyzing a coated state of an electrode plate of a secondary battery, with a first coating material and a second coating material being located on first and second surfaces of the electrode plate, respectively, the apparatus comprising:
a marker generation module;
an image acquisition module configured to acquire a target image including a first image and a second image of the first surface and the second surface of an electrode plate, respectively, wherein markers generated by the marker generation module are overlaid on the first and second surfaces of the electrode plate; and
a processor configured to determine a mismatch between coating properties of the first coating material on the first surface of the electrode plate and coating properties of the second coating material on the second surface of the electrode plate by analyzing the first and second images included in the target image using the markers on the target image acquired by the image acquisition module.

2. The apparatus of claim 1, wherein the image acquisition module includes an image recognition sensor, a first mirror, and a second mirror,
wherein the first and second mirrors are configured to reflect light incident from the first and second surfaces of the electrode plate, respectively, to the image recognition sensor, and
wherein the image recognition sensor images the first and second mirrors to acquire the target image including the first and second images on the first and second surfaces.

3. The apparatus of claim 2, wherein the first mirror is spaced apart from the first surface of the electrode plate and the second mirror is spaced apart from the second surface of the electrode plate,
wherein the first and second mirrors are disposed symmetrically with respect to an optical axis of the image recognition sensor, and
wherein the image recognition sensor has a field of view (FOV) including a first FOV that covers the first mirror and a second FOV that covers the second mirror.

4. The apparatus of claim 3, wherein the first and second FOVs correspond to the first and second images of the target image, respectively.

5. The apparatus of claim 2, wherein the markers include a first sub-marker in a form of a line and a second sub-marker in a form of a line that are formed from a base marker that is applied by the marker generation module toward the electrode plate, the first sub-marker and the second sub-marker being overlaid on the first and second surfaces, respectively, and
wherein the first sub-marker and the second sub-marker function as analysis criteria for the first and second images.

6. The apparatus of claim 5, wherein the base marker applied by the marker generation module is reflected to each of the first and second mirrors.

7. The apparatus of claim 5, wherein the first and second sub-markers are composed of continuous lines on the target image.

8. The apparatus of claim 7, wherein the coating properties include a position of a coating material on a surface of the electrode plate, and
wherein the processor determines a positional mismatch between the first and second coating materials using the first and second sub-markers.

9. The apparatus of claim 8, wherein the processor is configured to determine whether there is a positional mismatch between the first and second coating materials when a distance between the first sub-marker and the first coating material is different from a distance between the second sub-marker and the second coating material on the target image.

10. The apparatus of claim 4, wherein the FOV of the image recognition sensor further includes a third FOV that covers a third surface of the electrode plate,
wherein the target image further includes a third image acquired by the image recognition sensor capturing the third surface of the electrode plate, and
wherein the coating properties include a thickness of a coating material on a surface of the electrode plate.

11. The apparatus of claim 10, wherein the processor is configured to determine that there is a thickness mismatch between the first and second coating materials when a width of the first coating material is different from a width of the second coating material on the target image.

12. The apparatus of claim 1, wherein the marker generation module and the image acquisition module are a first marker generation module and a first image acquisition module, respectively, the first marker generation module is disposed on a first side of the electrode plate, and the first image acquisition module is disposed on the first side of the electrode plate and acquires a first target image including a first image and a second image of a first area of the first surface and a first area of the second surface, respectively,
markers generated by the first marker generation module are respectively overlaid on the first area of the first surface and the first area of the second surface of the electrode plate, and
wherein a second marker generation module is disposed on a second side of the electrode plate,
a second image acquisition module is disposed on the second side of the electrode plate and acquires a second target image including a fifth image and a sixth image of a second area of the first surface and a second area of the second surface, respectively, and
markers generated by the second marker generation module are respectively overlaid on the second area of the first surface and the second area of the second surface of the electrode plate.

13. The apparatus of claim 12, wherein the processor is configured to determine a mismatch between the coating properties of the first coating material in the first area of the first surface of the electrode plate and the coating properties of the second coating material in the first area of the second surface of the electrode plate by analyzing the first and second images included in the first target image using the markers on the first target image acquired by the first image acquisition module; and
determine a mismatch between the coating properties of the first coating material in the second area of the first surface of the electrode plate and the coating properties of the second coating material in the second area of the second surface of the electrode plate by analyzing the fourth and fifth images included in the second target image using the markers on the second target image acquired by the second image acquisition module.

14. The apparatus of claim 13, wherein the processor is configured to:
determine a mismatch between the coating properties of the first coating material in the first area of the first surface of the electrode plate and the coating properties of the first coating material in the second area of the first surface of the electrode plate; and
determine a mismatch between the coating properties of the second coating material in the first area of the second surface of the electrode plate and the coating properties of the second coating material in the second area of the second surface of the electrode plate.

15. The apparatus of claim 14, wherein the coating properties include a coating direction of a coating material on a surface of the electrode plate,
and the processor is configured to:
determine that there is a coating direction mismatch of the first coating material according to each area of the first surface when a distance between a marker overlaid on the first area of the first surface of the electrode plate and the first coating material on the first target image is different from a distance between a marker overlaid on the second area of the first surface of the electrode plate and the first coating material on the second target image; and
determine that there is a coating direction mismatch of the second coating material according to each area of the second surface when a distance between a marker overlaid on the first area of the second surface of the electrode plate and the second coating material on the first target image is different from a distance between a marker overlaid on the second area of the second surface of the electrode plate and the second coating material on the second target image.

16. The apparatus of claim 14, wherein the first target image further includes a third image of a third surface of the first side of the electrode plate acquired by the first image acquisition module, the second target image further includes a sixth image of a fourth surface of the second side of the electrode plate acquired by the second image acquisition module, and the coating properties include a thickness of a coating material on a surface of the electrode plate.

17. The apparatus of claim 16, wherein the processor is configured to:
determine that there is a thickness mismatch of the first coating material according to each area of the first surface when a width of the first coating material on the first target image is different from a width of the first coating material on the second target image, and
determine that there is a thickness mismatch of the second coating material according to each area of the second surface when a width of the second coating material on the first target image is different from a width of the second coating material on the second target image.

18. The apparatus of claim 12, wherein the first and second marker generation modules are symmetrically disposed on the first and second sides of the electrode plate, respectively, and
the first and second image acquisition modules are symmetrically disposed on the first and second sides of the electrode plate, respectively.

19. A method of analyzing a coated state of an electrode plate of a secondary battery, the method comprising:
acquiring, using a processor, a target image from an image acquisition module, wherein the image acquisition module is configured to acquire the target image including a first image and a second image of a first surface and a second surface of an electrode plate, respectively, with a first coating material and a second coating material being located on the first and second surfaces of the electrode plate, respectively, and with the marker generation module generating markers that are overlaid on the first and second surfaces of the electrode plate, and a first coating material and a second coating material are located on the first and second surfaces of the electrode plate, respectively;
analyzing, using the processor, the first and second images included in the target image; and
determining a mismatch between coating properties of the first coating material on the first surface of the electrode plate and coating properties of the second coating material on the second surface of the electrode plate.

20. An apparatus for analyzing a coated state of an electrode plate of a secondary battery, with a first coating material and a second coating material being located on first and second surfaces of the electrode plate, respectively, the apparatus comprising:
a first marker generation module configured to be disposed on a first side of an electrode plate;
a first image acquisition module configured to be disposed on the first side of the electrode plate and to acquire a first target image including an image of a first area of the first surface and an image of a first area of the second surface, respectively, wherein markers generated by the first marker generation module are respectively overlaid on the first area of the first surface and the first area of the second surface of the electrode plate, and the first coating material and the second coating material are located on the first and second surfaces of the electrode plate, respectively;
a second marker generation module configured to be disposed on a second side of the electrode plate;
a second image acquisition module configured to be disposed on the second side of the electrode plate and to acquire a second target image including an image of a second area of the first surface and an image of a second area of the second surface, respectively, wherein markers generated by the second marker generation module are overlaid on the second area of the first surface and the second area of the second surface of the electrode plate; and
a processor,
wherein the processor is configured to:
i) determine a mismatch between coating properties of the first coating material in the first area of the first surface of the electrode plate and coating properties of the second coating material in the first area of the second surface of the electrode plate by analyzing the first target image using the markers on the first target image,
ii) determine a mismatch between the coating properties of the first coating material in the second area of the first surface of the electrode plate and the coating properties of the second coating material in the second area of the second surface of the electrode plate by analyzing the second target image using the markers on the second target image,
iii) determine a mismatch between the coating properties of the first coating material in the first area of the first surface of the electrode plate and the coating properties of the first coating material in the second area of the first surface of the electrode plate using the markers on the first and second target images, or
iv) determine a mismatch between the coating properties of the second coating material in the first area of the second surface of the electrode plate and the coating properties of the second coating material in the second area of the second surface of the electrode plate using the markers on the first and second target images.
